(19) United States
(12) Patent Application Publication
(10) Pub. No.: US 2026/0054595 A1
(43) Pub. Date: Feb. 26, 2026

(54) METHOD OF RECEIVING ENERGY REQUEST FROM A CHARGING STATION

(71) Applicant: Volvo Car Corporation, Göteborg (SE)

(72) Inventors: Andreas ROPEL, TORSLANDA (SE); Jones SCHÖLD, Göteborg (SE); Fredrik HAAK, Ödsmål (SE); Ali FOTOUHI, Kungsbacka (SE); Virat ANDODARIYA, Göteborg (SE); Vijay ARUMUGAM, Göteborg (SE)

(73) Assignee: Volvo Car Corporation, Göteborg (SE)

(21) Appl. No.: 18/810,680

(22) Filed: Aug. 21, 2024

(51) Int. Cl. B60L 53/66; B60L 58/12; B60L 58/16; G06Q 30/0207; G06Q 50/06

(52) U.S. Cl. CPC B60L 53/665; B60L 58/12; B60L 58/16; G06Q 30/0215; G06Q 50/06; B60L 2240/72; B60L 2250/16

(57) ABSTRACT

A first vehicle is described. The first vehicle comprises: a memory; and a processor. The processor is operable to receive a first discharge request message from a charging station; analyze the first discharge request message; extract information of at least a location of the charging station and first required charge; determine whether a state-of-charge of battery packs of the first vehicle is sufficient to reach the charging station and provide the first required charge to the charging station; display a user interactive menu depicting a monetization opportunity and an optimized route to the charging station upon determining that the state-of-charge of the first vehicle is sufficient to reach the charging station and to provide the first required charge; and generate and communicate a first response message to the charging station based on interaction with the user interactive menu to schedule a discharging event with the charging station.

### FIELD OF THE INVENTION

The present disclosure relates generally to charging systems for electric vehicles. More specifically, the present disclosure relates to a system and method of receiving energy request from a charging station.

### BACKGROUND

As more and more cars become EV, more charging stations will be required. One type of charging station is emerging where there is a stationary battery that is connected to grid that provides charge to multiple cars. The stationary battery is large and periodically charges using the grid, usually over night or during non-peak usage. At these stations, the cars plug in as normal, and the cars are provided a charge directly from the stationary battery. However, during certain times of the day or year, the demand may be high and there may not be enough charge from the battery to satisfy needs of multiple cars. Instead of draining the battery and rejecting the additional users, a smart scheme needs to be implemented to address high demands.

Therefore, there is a long-felt need for a system and method of receiving energy request from a charging station.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In one or more embodiments described herein, systems, devices, computer-implemented methods, methods, apparatus and/or computer program products are presented that facilitate receiving energy request from a charging station.

In an aspect, a first vehicle is described. The first vehicle comprises: a memory; and a processor that is communicatively coupled to the memory. The processor is operable to receive a first discharge request message from a charging station; analyze the first discharge request message; extract information of at least a location of the charging station and first required charge from the first discharge request message; determine whether a state-of-charge of one or more second battery packs of the first vehicle is sufficient to reach the location of the charging station and provide the first required charge to the charging station; display a user interactive menu onto a display depicting a monetization opportunity and an optimized route to the location of the charging station upon determining that the state-of-charge of the one or more second battery packs of the first vehicle is sufficient to reach the charging station and to provide the first required charge to the charging station; and generate and communicate a first response message to the charging station based on interaction with the user interactive menu to schedule a discharging event with the charging station.

In one aspect, a method is described. The method comprises: receiving a first discharge request message from a charging station; analyzing the first discharge request message; extracting information of at least a location of the charging station and first required charge from the first discharge request message; determining whether a state-of-charge of one or more second battery packs of a first vehicle is sufficient to reach the location of the charging station and provide the first required charge to the charging station; displaying a user interactive menu onto a display depicting a monetization opportunity and an optimized route to the location of the charging station upon determining that the state-of-charge of the one or more second battery packs of the first vehicle is sufficient to reach the charging station and to provide the first required charge to the charging station; and generating and communicating a first response message to the charging station based on interaction with the user interactive menu to schedule a discharging event with the charging station.

In one aspect, a non-transitory computer readable storage medium is described. The non-transitory computer readable storage medium comprising a sequence of instructions, which when executed by a processor causes: receiving a first discharge request message from a charging station; analyzing the first discharge request message; extracting information of at least a location of the charging station and first required charge from the first discharge request message; determining whether a state-of-charge of one or more second battery packs of a first vehicle is sufficient to reach the location of the charging station and provide the first required charge to the charging station; displaying a user interactive menu onto a display depicting a monetization opportunity and an optimized route to the location of the charging station upon determining that the state-of-charge of the one or more second battery packs of the first vehicle is sufficient to reach the charging station and to provide the first required charge to the charging station; and generating and communicating a first response message to the charging station based on interaction with the user interactive menu to schedule a discharging event with the charging station.

The methods and systems disclosed herein may be implemented in any means for achieving various aspects and may be executed in a form of a non-transitory machine-readable medium embodying a set of instructions that, when executed by a machine, causes the machine to perform any of the operations disclosed herein. Other features will be apparent from the accompanying drawings and from the detailed description that follows.

### BRIEF DESCRIPTION OF THE FIGURES

These and other aspects of the present disclosure will now be described in more detail, with reference to the appended drawings showing exemplary embodiments, in which:

FIG. 1 illustrates a system, according to one or more embodiments.

FIG. 2 illustrates a charging station method, according to one or more embodiments.

FIG. 3 illustrates a method, according to one or more embodiments.

FIG. 4 illustrates a non-transitory computer readable storage medium block diagram, according to one or more embodiments.

FIG. 5 illustrates a battery pack comprising an individual battery, according to one or more embodiments.

FIG. 6 illustrates a battery pack comprising a plurality of batteries, according to one or more embodiments.

FIG. 7 schematically shows a battery pack comprising a battery and a battery management system, according to one or more embodiments.

FIG. 8 illustrates a first discharge request message, according to one or more embodiments.

FIG. 9 illustrates a first response message, according to one or more embodiments.

FIG. 10 illustrates a second discharge request message, according to one or more embodiments.

FIG. 11 illustrates a second response message, according to one or more embodiments.

FIG. 12 illustrates a charging station block diagram, according to one or more embodiments.

FIG. 13 illustrates a method, according to one or more embodiments.

FIG. 14 illustrates a non-transitory computer readable storage medium, according to one or more embodiments.

FIG. 15A illustrates a charging station broadcasting the discharge request message to electric vehicles with a predefined geographical range, according to one or more embodiments.

FIG. 15B illustrates a charging station broadcasting the discharge request message to electric vehicles with a predefined geographical range having non-contiguous zones, according to one or more embodiments.

FIG. 15C illustrates a charging station broadcasting the discharge request message to electric vehicles with a predefined geographical range having contiguous zones, according to one or more embodiments.

FIG. 16 illustrates a communication flow between a charging station, a first vehicle, and a second vehicle, according to one or more embodiments.

FIG. 17 illustrates a communication flow between a charging station, and a first vehicle, according to one or more embodiments.

FIG. 18 illustrates a communication flow between a charging station, and a second vehicle, according to one or more embodiments.

FIG. 19 illustrates a charge request message sent by a second vehicle to the charging station, according to one or more embodiments.

FIG. 20 illustrates a response message sent by a charging station to a second vehicle, according to one or more embodiments.

FIG. 21 illustrates a first vehicle for providing charge to the charging station, according to one or more embodiments.

FIG. 22 illustrates a method, according to one or more embodiments.

FIG. 23 illustrates a non-transitory computer readable storage medium, according to one or more embodiments.

FIG. 24A shows a structure of the neural network/machine learning model with a feedback loop.

FIG. 24B shows a structure of the neural network/machine learning model with reinforcement learning.

FIG. 25A shows a block diagram of the cyber security module in view of the system and server.

FIG. 25B shows an embodiment of the cyber security module.

FIG. 25C shows another embodiment of the cyber security module.

Other features of the present embodiments will be apparent from the accompanying drawings and from the detailed description that follows.

### DETAILED DESCRIPTION

For simplicity and clarity of illustration, the figures illustrate the general manner of construction. The description and figures may omit the descriptions and details of well-known features and techniques to avoid unnecessarily obscuring the present disclosure. The figures exaggerate the dimensions of some of the elements relative to other elements to help improve understanding of embodiments of the present disclosure. The same reference numeral in different figures denotes the same element.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs.

Unless defined otherwise, all technical and scientific terms used herein have the same meaning as commonly understood by one with ordinary skill in the art.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

As used herein, the terms “left,” “right,” “front,” “back,” “top,” “bottom,” “over,” “under” and the like in the description and in the claims, if any, are for descriptive purposes and not necessarily for describing permanent relative positions. The terms so used are interchangeable under appropriate circumstances such that the embodiments of the apparatus, methods, and/or articles of manufacture described herein are, for example, capable of operation in other orientations than those illustrated or otherwise described herein.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the terms.

As used herein, the terms “couple,” “coupled,” “couples,” “coupling,” and the like refer to connecting two or more elements mechanically, electrically, and/or otherwise. Two or more electrical elements may be electrically coupled together, but not mechanically or otherwise coupled together. Coupling may be for any length of time, e.g., permanent, or semi-permanent or only for an instant. “Electrical coupling” includes electrical coupling of all types. The absence of the word “removably,” “removable,” and the like, near the word “coupled” and the like does not mean that the coupling, etc., in question is or is not removable.

As used herein, the term “or” means an inclusive “or” rather than an exclusive “or.” That is, unless specified otherwise, or clear from context. “X employs A or B” means any of the natural inclusive permutations. That is, if X employs A; X employs B; or X employs both A and B, then “X employs A or B” is satisfied under any of the foregoing instances.

As used herein, two or more elements or modules are “integral” or “integrated” if they operate functionally together. Two or more elements are “non-integral” if each element can operate functionally independently.

As used herein, the term “real-time” refers to operations conducted as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Digital electronic circuitry, or in computer software, firmware, or hardware, including the structures disclosed in this specification and their structural equivalents, or in combinations of one or more of them may realize the implementations and all of the functional operations described in this specification. Implementations may be as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of a digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc., may embed a computer. Computer readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship to each other.

Embodiments may comprise or utilize a special purpose or general purpose computer including computer hardware. Embodiments within the scope of the present invention may also include physical and other computer readable media for carrying or storing computer-executable instructions and/or data structures. Such computer readable media can be any media accessible by a general purpose or special purpose computer system. Computer readable media that store computer-executable instructions are physical storage media. Computer readable media that carry computer-executable instructions are transmission media. Thus, by way of example and not limitation, embodiments of the invention can comprise at least two distinct kinds of computer readable media: physical computer readable storage media and transmission computer readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer readable media includes combinations of the above, that enable the transport of electronic data between computer systems and/or modules and/or other electronic devices. Further, upon reaching various computer system components, program code in the form of computer-executable instructions or data structures can be transferred automatically from transmission computer readable media to physical computer readable storage media (or vice versa). For example, computer-executable instructions or data structures received over a network or data link can be buffered in RAM within a Network Interface Module (NIC), and then eventually transferred to computer system RAM and/or to less volatile computer readable physical storage media at a computer system. Thus, computer system components that also (or even primarily) utilize transmission media may include computer readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

The following terms and phrases, unless otherwise indicated, shall have the following meanings.

As used herein, the term “sensor module” refers to a unit that contains components or circuits in addition to the sensors. The additional components or circuits make the sensor easy to use. The sensor module may be an integrated circuit comprising additional components and sensors adaptable for an application. The sensor module may comprise one or more sensors that operate functionally together. For example, the one or more cameras and the one or more sensors within the sensor module are integrated with one another to determine interior features and exterior features. The sensors within the sensor module may operate in an integrated manner to monitor the environmental conditions, external surroundings, ambient lighting, occupants within the vehicle, etc.

As used herein, the term “electric vehicle (EV)” refers to an automobile, as defined in 49 CFR 523.3, intended for highway use, powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets, roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

As used herein, the term “plug-in electric vehicle (PEV)” refers to an Electric Vehicle that recharges the on-vehicle primary battery by connecting to the power grid.

As used herein, the term “plug-in vehicle (PV)” refers to an electric vehicle rechargeable through wireless charging from an electric vehicle supply equipment (EVSE) without using a physical plug or a physical socket.

As used herein, the term “heavy duty vehicle (HD Vehicle)” refers to any four-or-more wheeled vehicle as defined in 49 CFR 523.6 or 49 CFR 37.3 (bus).

As used herein, the term “light duty plug-in electric vehicle” refers to a three or four-wheeled vehicle propelled by an electric motor drawing current from a rechargeable storage battery or other energy devices for use primarily on public streets, roads and highways and rated at less than 4,545 kg, (10,000 lbs.) gross vehicle weight.

As used herein, the term “state-of-health (SoH)” refers to a figure of merit of the condition of a battery pack, compared to its ideal conditions. The state-of-health (SoH) of a battery pack describes the difference between a battery pack being studied and a fresh battery pack and considers cell aging. The SoH is defined as the ratio of the maximum battery charge to its rated capacity. It may be expressed in percentage form. The battery pack may comprise one or more batteries.

As used herein, the term “charging station” refers to a device that includes at least one docking terminal with a charger for charging a battery pack. The battery pack may comprise one or more batteries. The term “charging station,” as used further refers to an apparatus that can function as a source of power for charging the battery pack of an electric vehicle including facilitating data communications between the electric vehicle and the charging station. The communications may be established through a wired connection or a wireless connection. The charging station is also capable of charging the electric vehicle either through a wired connection or a wireless connection.

As used herein, the term “charging session” refers to an event starting when a user or a vehicle initiates a refueling event (e.g., charging event) and stops when a user or a vehicle ends a refueling event (e.g., charging event). The charging session further refers to a charging occurrence for a single EV, during which a certain amount of energy is transmitted to the EV, measured in duration according to the time of the EV's plug-in (wireless or wired) to the EVSE to the time of the EV's physical plug-out from the EVSE.

As used herein, the term “optimized route” refers to a route to the intended destination covering shortest distance through which the vehicle can travel with less traffic condition and in less time. The optimized route refers to a route through which the vehicle travels with fuel, battery charge, and with efficiency.

As used herein, the term “battery pack” as used herein refers to a set of any number of identical batteries or individual cells of a battery. The “battery pack” may also refer to a set of non-identical batteries. The batteries in the battery pack may be configured in a series, parallel or a mixture of both to deliver the desired voltage, capacity, and/or power density.

As used herein, the term “control unit” or “control module” or “electronic control unit” refers to a functional unit in a computer system that controls one or more units of the peripheral equipment. For example, it may be a component of a charging system that provides instructions or signals to the charger unit to charge the battery pack as per the charging requirement.

As used herein, the term “electronic control unit” (ECU), also known as an “electronic control module” (ECM), is a system that controls one or more subsystems. An ECU may be installed in a car or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles'computer or vehicles'central computer and may include separate computers. In an example, the electronic control unit can be embedded in automotive electronics. In another example, the electronic control unit is wirelessly coupled with the automotive electronics.

As used herein, the term “infotainment system” or “infotainment unit” or “in-vehicle infotainment system” (IVI) as used herein refers to a combination of systems which are used to deliver entertainment and information. In an example, the information may be delivered to the driver and the passengers of a vehicle through /dio/ video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

As used herein, the term “charging sequence” as used herein refers to a charging pattern defined by the charging system or the charging station based on the battery parameters (e.g., state-of-charge, state-of-health) and charging time. The charging sequence may comprise a charging level for a predefined charging time segment. The charging sequence may also comprise a charging level for a predefined portion (e.g., healthy cells, degraded cells) of the battery pack. The charging level may comprise a regular charging, a fast charging, and a trickle charging.

As used herein, the term “maximum charging” or “optimally charging” as used herein refers to a maximum rate at which the charging is provided to the battery pack during the charging time without damaging the battery pack.

As used herein, the term “charging duration” as used herein refers to a time allotted for charging. The user may provide the charging duration. The charging duration may also be determined by the charging station or the charging system. The charging duration may be split into charging time segments. Each charging time segment may correspond to a different charging level. Each charging time segment may correspond to charging the different portion of the battery pack.

As used herein, the term “required charge” typically refers to the amount of energy needed to replenish the battery pack of the vehicle to a desired level of charge. The required charge can vary based on factors such as the current state of charge (SoC) of the battery, the desired driving range, and the efficiency of the charging process. The required charge may be inclusive of charge needed for EV to reach the charging station, charge needed to complete the itinerary, charge needed to be provided to other entities such as other vehicles, charging stations, etc.

As used herein, the term “monetary value” refers to a cost of selling or buying power from other entity (vehicle, charging station, etc.).

As used herein, the term “mode of charging” refers to a manner by which the power or charge is transferred between entities. The mode of charging includes one of wired charging and wireless charging.

As used herein, the term “charging specification” encompasses various technical details related to the charging process, including voltage, current, power output, connector types, and charging protocols. The charging specifications ensure compatibility between EVs and charging infrastructure, enabling efficient and safe charging.

As used herein, the term “confirmation” refers to a response that affirms or verifies or agrees to the particulars/details shared with the request message.

As used herein, the term “negotiation” refers to a response that provides updated particulars/details in response to the particulars/details shared with the request message.

As used herein, the term “denial” refers to a response that involves disagreement to the particulars/details in the request message.

As used herein, the term “demand percentile” refers to a proportion or percentage of the total charging demand accounted for the charging station.

As used herein, the term “geographical range” refers to the extent or distance over which the vehicle or other entity is to be communicated within a geographic area. The term “geographical range” refers to the coverage area or spatial extent over which charging infrastructure is available for electric vehicles (EVs) for charging or discharging within a geographic region.

As used herein, the term “state-of-charge (SoC)” refers to the level of charge of an electric battery pack relative to its capacity. The units of SoC are percentage points (0%=empty; 100% =full). An alternative form of the same measure is the depth of discharge (DoD), the inverse of SoC (100%=empty; 0%=full). SoC is normally used when discussing the current state of a battery in use, while DoD is most often seen when discussing the lifetime of the battery after repeated use.

As used herein, the term “threshold charge level” refers to a minimum charge level of the electric battery pack (having the one or more batteries) of the vehicle necessary to operate a predefined function of the vehicle. The threshold charge level may be preset by the processor of the control module. The threshold charge level can be altered by the processor.

As used herein, the term “geographical range” refers to a distance range, computed, based on the state-of-charge. The geographical range may refer to a distance range that the vehicle can travel using the state-of-charge. The geographical range may comprise one or more zones. The one or more zones may be one of contiguous and non-contiguous. The geographical range may comprise one or more zones surrounding the charging station.

As used herein, the term “bidirectional communication” refers to an exchange of data between two components. In an example, the first component can be a vehicle and the second component can be an infrastructure that is enabled by a system of hardware, software, and firmware. This communication is typically wireless. In another example, the first component can be a charging system and the second component can be a charging station.

As used herein, the term “message structure” refers to a structure of a communication message when a query and fetch operation occurs. It comprises a payload and a header, where the payload includes the quantitative value of the information that is shared, and the header includes reference to the information being shared. The message structure acts as a superstructure to accommodate any sub protocol structure such as AMQP, MQTT, ZigBee, etc.

As used herein, the term “communication system” or “communication module” as used herein refers to a system which enables the information exchange between two points. The process of transmission and reception of information is called communication. The major elements of communication include but are not limited to a transmitter of information, channel or medium of communication and a receiver of information.

As used herein, the term “plugging” refers to insertion of the charging cable into the charging port. The charging cable may comprise a charger plug that fits exactly into the charging port. The charger plug may comprise metal pins capable of supplying power to the vehicle for charging the battery pack.

As used herein, the term “unplugging” refers to the removal of the charging cable away from the charging port.

As used herein the term “itinerary” refers to a travel plan of a user. The itinerary comprises scheduled events, their locations, duration, time, date, etc. In an embodiment, “itinerary” refers to a trip to work, trips to a doctor, trips to a grocery store, and the like. The itineraries may also include other infrequently used itineraries, such as vacation trips, extended travel, short term trips, quick trips, and the like. The itineraries may be divided into a predicted departure time, departure point, a start time, a destination, and an end time. The itinerary may also include intermediate waypoints that further define the route. The itinerary may include, without limitation, departure point, departure time, destination, intended route, and optional intermediate waypoints.

As used herein the term “amount of charging needed” refers to a charge that is required to reach the destination (i.e. charge required to travel from current location of vehicle to the charging station) and the charge to be released. The amount of charging needed may also include the charge required to complete an upcoming action in the schedule/itinerary.

As used herein, the term “Cryptographic protocol” is also known as security protocol or encryption protocol. It is an abstract or concrete protocol that performs a security-related function and applies cryptographic methods often as sequences of cryptographic primitives. A protocol describes usage of the algorithms. A sufficiently detailed protocol includes details about data structures and representations, to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

Secure application-level data transport widely uses cryptographic protocols. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation.

Networking switches use cryptographic protocols, like Secure Socket Layer (SSL) and Transport Layer Security (TLS), the successor to SSL, to secure data communications over a wireless network.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “Sensor” is a device that detects and measures physical properties from the surrounding environment and converts this information into electrical or digital signals that can be interpreted by either a human or a machine for further processing. Sensors play a crucial role in collecting data for various applications across industries. Sensors may be made of electronic, mechanical, chemical, or other engineering components. Most sensors are electronic (the data is converted into electronic data), but some are simpler, such as a glass thermometer, which presents visual data. Examples include sensors to measure temperature, pressure, humidity, proximity, light, acceleration, orientation etc. In an embodiment, sensors may be removably or fixedly installed within the vehicle and may be disposed in various arrangements to provide information to the autonomous operation features. The sensors may include one or more of a GPS unit, a radar unit, a LIDAR unit, an ultrasonic sensor, an infrared sensor, an inductance sensor, a camera, an accelerometer, a tachometer, a tension sensor, or a speedometer. Some of the sensors (e.g., radar, LIDAR, or camera units) may actively or passively scan the interior of the vehicle for the presence of occupants (e.g., child, adult, kids, passenger, driver, etc.) to determine notifications in the dashboard (charging level, charging duration, SoC, etc.).

The term “vehicle” as used herein refers to a thing used for transporting people or goods. Automobiles, cars, trucks, buses, etc., are examples of vehicles.

The term “electronic control unit” (ECU), also known as an “electronic control module” (ECM), is usually a module that controls one or more subsystems. Herein, an ECU may be installed in a car or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles'computer or vehicles'central computer and may include separate computers. In an example, the electronic control unit can be an embedded system in automotive electronics. In another example, the electronic control unit is wirelessly coupled with the automotive electronics.

The terms “non-transitory computer readable medium” and “computer readable medium” include a single medium or multiple media such as a centralized or distributed database, and/or associated caches and servers that store one or more sets of instructions. Further, the terms “non-transitory computer readable medium” and “computer readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

The term “Vehicle Data bus” as used herein represents the interface to the vehicle data bus (e.g., CAN, LIN, Ethernet/IP, FlexRay, and MOST) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in an RS-232 serial transmission. A software handshake sends codes such as “synchronize” (SYN) and “acknowledge” (ACK) in a TCP/IP transmission.

As used herein, the term “power source” refers to various systems or devices that provide energy to perform work or power electronic devices. The charging station receives power from the power source to charge electric vehicles. In one embodiment, the power source supplies power to the charging station to directly convert and supply the required power to the electric vehicle. In one embodiment, the power source supplies power to the charging station to charge the battery contained within the charging station. The battery within the charging station may supply power during demand and/or off-grid.

As used herein, the term “discharge request message” refers to a formal communication often used to request the discharge or release of power from electric/hicles/or other entities. The discharge power from the electric vehicle may be used to charge other entity (e.g., another vehicle, charging station, etc.). The discharge request message may comprise particulars/details such as at least one of a required charge, a monetary value, a charging station Identification number, a mode of charging, and a charging sequence.

As used herein, the term “charge request message” refers to a formal communication often used to request charging to electric/hicles/or other entities. The charge request message may comprise particulars/details such as at least one of a required charge, a monetary value, a charging station identification number, a mode of charging, a scheduled time period, a charging duration, and a charging sequence.

As used herein, the term “peer-to-peer (P2P) connection” refers to a decentralized communication model in which each participant (peer) in the network can act as both a client and a server, sharing resources and communicating directly with other peers. This model contrasts with traditional client-server architecture, where clients request resources and services from centralized servers. P2P connections are commonly used for various applications, such as file sharing, decentralized computing, and communication platforms. In one embodiment, P2P connection may be used for both communication and charge transfer.

As used herein, the term “response message” refers to a formal reply message to the charge request message/discharge request message. The response message may comprise one of a confirmation, a negotiation, and a denial. The response message may be a counter message. The counter message comprises revised particulars/details in the request message (charge request message/ischarge request message).

As used herein, the term “one-to-many connection” refers to a scenario in the peer-to-peer connection where one peer node communicates or shares data and/or transfers charge with multiple other peer nodes.

As used herein, the term “many-to-one connection” refers to a scenario in the peer-to-peer connection where multiple peer nodes communicate or share data and/or transfers charge with a single peer node.

As used herein, the term “many-to-many connection” refers to a scenario in the peer-to-peer connection where multiple peer nodes communicate or share data and/or transfers charge with multiple peer nodes.

As used herein, the term “one-to-one connection” refers to a direct communication link established between two individual peer nodes for communicating or sharing data and/or transferring charge.

As used herein, the term “bidirectional communication” refers to two-way communication where information flows in both directions between two parties.

As used herein, the term “user interactive menu” refers to a digital interface component designed to facilitate user navigation and interaction with content on websites, applications, or other digital platforms. The user interactive menu is characterized by its ability to respond to user inputs, providing a dynamic and engaging experience.

As used herein, the term “discharging event” refers to the process where an EV's battery releases stored energy for various applications. In one embodiment, the vehicle may release stored energy via technology such as Vehicle-to-Everything (V2X), which includes Vehicle-to-Grid (V2G), Vehicle-to-Home (V2H), and Vehicle-to-Load (V2L), etc.

As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

As used herein, the term “vehicle computer system” refers to a system in automotive electronics that controls one or more of the electrical systems or subsystems in a vehicle. The computer executes a large number of different software functions in the powertrain, chassis, driver assistance, and infotainment domains, etc., that are executed on separate control units. The vehicle computer system may be communicatively coupled with an external device of a user.

As used herein, the term “infotainment system” or “infotainment unit” or “in-vehicle infotainment system” (IVI) as used herein refers to a combination of systems which are used to deliver entertainment and information. In an example, the information may be delivered to the driver and the passengers of a vehicle through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

As used herein, the term “machine learning” refers to algorithms that give a computer the ability to learn without being explicitly programmed, including algorithms that learn from and make predictions about data. Machine learning algorithms include, but are not limited to, decision tree learning, artificial neural networks (ANN) (also referred to herein as a “neural net”), deep learning neural network, support vector machines, rules-based machine learning, random forest, etc. For the purposes of clarity, algorithms such as linear regression or logistic regression can also be used as part of a machine learning process. However, it is understood that using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. Statistical modelling relies on finding relationships between variables (e.g., mathematical equations) to predict an outcome. The ANN may be featured with a feedback loop to adjust the system output dynamically as it learns from the new data as it becomes available. In machine learning, backpropagation and feedback loops are used to train the AI/ML model improving the model's accuracy and performance over time.

As used herein, the term “communication” refers to the transmission of information and/or data from one point to another. Communication may be by means of electromagnetic waves. It is also a flow of information from one point, known as the source, to another, the receiver. Communication comprises one of the following: transmitting data, instructions, and information or a combination of data, instructions, and information. Communication happens between any two communication systems or communicating units. The term “in communication with” may refer to any coupling, connection, or interaction using electrical signals to exchange information or data, using any system, hardware, software, protocol, or format, regardless of whether the exchange occurs wirelessly or over a wired connection. The term “communication” includes systems that combine other more specific types of communication, such as V2I (Vehicle-to-Infrastructure), V2I (Vehicle-to-Infrastructure), V2N (Vehicle-to-Network), V2V (Vehicle-to-Vehicle), V2P (Vehicle-to-Pedestrian), V2D (Vehicle-to-Device) and V2G (Vehicle-to-Grid) and Vehicle-to-Everything (V2X) communication. V2X communication is the transmission of information from a vehicle to any entity that may affect the vehicle, and vice versa. The main motivations for developing V2X are occupant safety, road safety, traffic efficiency and energy efficiency. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.). Further, the emergency communication apparatus is configured on a computer with the communication function and is connected for bidirectional communication with the on-vehicle emergency report apparatus by a communication line through a radio station and a communication network such as a public telephone network or by satellite communication through a communication satellite. The emergency communication apparatus is adapted to communicate, through the communication network, with communication terminals including a road management office, a police station, a fire department, and a hospital. The emergency communication apparatus can also be connected online with the communication terminals of the persons or vehicles concerned, associated with the occupant or vehicle, and the driver or vehicle receiving the service of the emergency-reporting vehicle.

As used herein, the term “message structure” refers to a structure of a communication message when a query and fetch operation occurs. It comprises a payload and a header, where the payload includes the quantitative value of the information that is shared, and the header includes reference to the information being shared. The message structure acts as a superstructure to accommodate any sub protocol structure such as AMQP, MQTT, ZigBee, etc.

As used herein, the term “communication system” or “communication module” as used herein refers to a system which enables the information exchange between two points. The process of transmission and reception of information is called communication. The major elements of communication include but are not limited to a transmitter of information, channel or medium of communication and a receiver of information.

As used herein, the term “entity” refers to a unit or item or apparatus that exists and can be identified as a distinct unit. For example, the entity may be a vehicle, a train, etc.

As used herein, the term “command” refers to instructions given to perform a specific function. The command may specify a particular operation such as performing arithmetic calculations, moving data between memory locations, branching to a different part of the program, or interacting with input/output devices. Commands are encoded in binary format and are represented by a sequence of bits that the appropriate module interprets and executes. The module fetches instructions and decodes them to determine the operation to perform, and then executes them accordingly.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

The term “vehicle” as used herein refers to a thing used for transporting people or goods. Automobiles, cars, trucks, buses, etc., are examples of vehicles.

The terms “non-transitory computer readable medium” and “computer readable medium” include a single medium or multiple media such as a centralized or distributed database, and/or associated caches and servers that store one or more sets of instructions. Further, the terms “non-transitory computer readable medium” and “computer readable medium” include any tangible medium that is capable of storing, encoding, or carrying a set of instructions for execution by a processor that, for example, when executed, cause a system to perform any one or more of the methods or operations disclosed herein. As used herein, the term “computer readable medium” is expressly defined to include any type of computer readable storage device and/or storage disk and to exclude propagating signals.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in an RS-232 serial transmission. A software handshake sends codes such as “synchronize” (SYN) and “acknowledge” (ACK) in a TCP/IP transmission.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “autonomous mode” as used herein refers to a vehicle operating mode which is independent and unsupervised.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication protocol” as used herein refers to standardized communication between any two systems. An example of a communication protocol is the DSRC protocol. The DSRC protocol uses a specific frequency band (e.g., 5.9 GHz) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the IEEE and SAE International.

The term “alert” or “alert signal” refers to a communication to attract attention. An alert may include visual, tactile, audible alert, and a combination of these alerts to warn drivers or occupants. These alerts allow receivers, such as drivers or occupants, the ability to react and respond quickly.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” will be encrypted as “0805121215,” and this value will be transmitted over the network to the destination or recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

The term “in communication with” as used herein, refers to any coupling, connection, or interaction using electrical signals to exchange information or data, using any system, hardware, software, protocol, or format, regardless of whether the exchange occurs wirelessly or over a wired connection.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

As used herein, the term “network” may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

The term “autonomous vehicle” also referred to as self-driving vehicle, driverless vehicle, robotic vehicle as used herein refers to a vehicle incorporating vehicular automation, that is, a ground vehicle that can sense its environment and move safely with little or no human input. Self-driving vehicles combine a variety of sensors to perceive their surroundings, such as thermographic cameras, Radio Detection and Ranging (radar), Light Detection and Ranging (lidar), Sound Navigation and Ranging (sonar), Global Positioning System (GPS), odometry and inertial measurement unit. Control systems, designed for the purpose, interpret sensor information to identify appropriate navigation paths, as well as obstacles and relevant signage.

As used herein, the term “semi-autonomous vehicle” refers to vehicles that can operate for extended periods with little human input. A semi-autonomous vehicle cannot drive itself at all times, but does automate some driving functions under ideal conditions like highway driving. A semi-autonomous vehicle may use “autopilot” features. In one embodiment, semi-autonomous vehicles may be able to keep in lane, and they may also be able to park themselves, but they are not self-driving. The semi-autonomous vehicles act independently to some degree.

As used herein the term “connection” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networking. A channel is used for information transfer of, for example a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “protocol” as used herein refers to a procedure required to initiate and maintain communication; a formal set of conventions governing the format and relative timing of message exchange between two communications terminals; a set of conventions that govern the interaction of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications within a computer system or network; a formal set of conventions governing the format and relative timing of message exchange in a computer system; a set of semantic and syntactic rules that determine the behavior of functional units in achieving meaningful communication; a set of semantic and syntactic rules for exchanging information.

As used herein, the term “component” broadly construes hardware, firmware, and/or a combination of hardware, firmware, and software.

The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. For example, the computer readable storage medium can be, but is not limited to, an electronic storage device, a magnetic storage device, an optical storage device, an electromagnetic storage device, a superconducting storage device, and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, does not construe transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein are downloadable to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA), and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter described herein is in the general context of computer-executable instructions of a computer program product that runs on a computer and/or computers, those skilled in the art will recognize that the one or more embodiments herein also can be implemented in combination with one or more other program modules. Program modules include routines, programs, components, data structures, and/or the like that perform particular tasks and/or implement particular abstract data types. Moreover, other computer system configurations, including single-processor and/or multiprocessor computer systems, mini-computing devices, mainframe computers, as well as computers, hand-held computing devices (e.g., PDA, phone), microprocessor-based or programmable consumer and/or industrial electronics and/or the like can practice the herein described computer-implemented methods. Distributed computing environments, in which remote processing devices linked through a communications network perform tasks, can also practice the illustrated aspects. However, stand-alone computers can practice one or more, if not all, aspects of the one or more embodiments described herein. In a distributed computing environment, program modules can be located in both local and remote memory storage devices.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

As it is employed in the subject specification, the term “processor” can refer to any computing processing unit and/or device comprising, but not limited to, single-core processors; single-processors with software multi-thread execution capability; multi-core processors; multi-core processors with software multi-thread execution capability; multi-core processors with hardware multi-thread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular based transistors, switches and/or gates, in order to optimize space usage and/or to enhance performance of related equipment. A combination of computing processing units can implement a processor.

Herein, terms such as “store,” “storage,” “data store,” data storage,” “database,” and any other information storage component relevant to operation and functionality of a component refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, and/or nonvolatile random access memory (RAM) (e.g., ferroelectric RAM (FeRAM). Volatile memory can include RAM, which can function as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein include, without being limited to including, these and/or any other suitable types of memory.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

Business problem 1: As most vehicles today are electric vehicles, there is no sufficient charging station to charge electric vehicles. The charging station may also run out of power to charge the vehicles. The charging station has to receive power from external sources to address charging demands.

Business Solution 1: The business solution implements a charging station with a stationary and large battery. The stationary battery enables the charging station to get charged during night time or during non-peak hours. The charging station looks for external power sources to charge the stationary battery of the charging station. The charging station may be capable of receiving power from other entities such as electric vehicles. The charging station then checks for a vehicle that is electrically plugged in and has sufficient power to donate charge for money. The charging station then communicates discharge request messages to those vehicles. By implementing this solution, the stationary battery of the charging station may receive power from electric vehicles.

Technical problem 1: As more and more cars become EV, more charging stations will be required. One type of charging station emerging is where there is a stationary battery that is connected to a grid that provides charge to multiple cars. The stationary battery is large and periodically charges using the grid, usually overnight or during non-peak usage. At these stations, the cars plug in as normal, and the cars are provided a charge directly from the stationary battery. However, during certain times of the day or year, the demand may be high and there may not be enough charge from the battery to satisfy the needs of multiple cars. Instead of draining the battery and rejecting the additional users, a smart scheme needs to be implemented to address high demands.

Technical Solution 1: In an aspect, the charging stations comprise peer-to-peer charging that allows first car to provide charge to one or more cars plugged into a charger. The charging station comprises a system that can extract energy from the first car, provide a monetary value for discharging and store the energy in the stationary battery or directly distribute to one or more cars plugged into the charger. The monetary value can be negotiated or be set by the system based on demand. For example, if more cars plugged in for charging and available energy from the stationary battery dropped below a threshold, the higher the monetary value is offered to the first car. In an aspect, the monetary value can be adjusted frequently or fixed over a duration of discharge. Here, the first car is provided with a monetary value for discharge. If accepted, the first car plugs into the charger. The first car provides an amount of charge it can discharge. The system initiates discharge while monitoring the health of the battery. The system alerts the driver if monetary value changes or needs more charge than initially set. For example, the driver indicates that it has 50% charge available at X monetary value. Thereafter, the charging station accepts the terms or requests more charge. The user can decline to provide more charge (may be based on the user needs). The user can negotiate a higher price for additional charge. The charging station can communicate a new request for more charge once it has used up the initial 50%. The new request message comprises required charge and monetary value that can be adjusted by the user either on a mobile device or at the infotainment system. The first car system may provide maximum energy to discharge based on predicted future use of energy (e.g., required energy to reach a destination).

Technical Result 1: The charging station communicates the discharge request message to electric vehicles. The processor within the electric vehicle may analyze the discharge request message and either accepts, denies, or negotiates with the request message. The negotiation may go up to one or more iterations and finally may agree to the monetization opportunity. Upon receiving confirmation of the monetization opportunity, the charging station may receive charge from the electric vehicles.

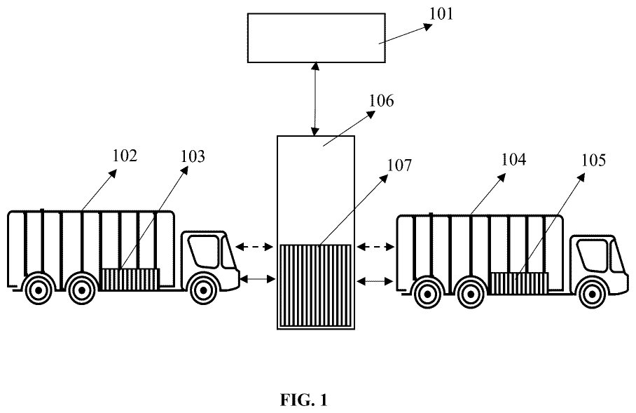

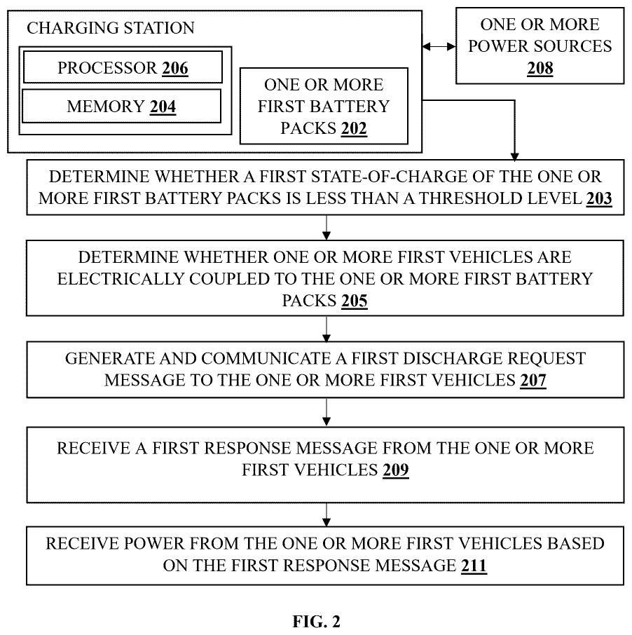

Technical Details Specific to Technical Result: As an Example, FIG. 1 Illustrates a system, according to one or more embodiments. The system depicts an environment at a charging station. The charging station 106 is capable of both receiving charge from first vehicles 102 and providing charge to second vehicles 105. The terms “first,” “second,” “third,” and the like in the description and in the claims, if any, distinguish between similar elements and do not necessarily describe a particular sequence or chronological order. The first vehicles 102 may be electric vehicles and hybrid vehicles. The first vehicles 102 may be one of autonomous vehicles, semi-autonomous vehicles, and non-autonomous vehicles. The first vehicles 102 may comprise one or more second battery packs 103. The charging station 106 comprises one or more first battery packs 107, a processor, and a memory (explained in detail in FIG. 2). The one or more battery packs 107 of the charging station may receive power from one or more power sources 101. The one or more power sources 101 may be one of an electricity grid, a solar grid, a renewable energy based power generation source, a non-renewable energy based power generation source, etc. The one or more battery packs 107 may be large and stationary at the charging station 106. The one or more battery packs 107 may be used to charge vehicles off-grid. The one or more battery packs 107 may also be used to charge vehicles during high charging demand and no charging spots available. The one or more battery packs 107 are large and periodically charges using the grid, usually overnight or during non-peak usage.

In an embodiment, the processor of the charging station 106 is capable of establishing a peer-to-peer (P2P) connection with the first vehicles 102 and the second vehicles 104. The second vehicles 104 may comprise one or more third battery packs 105. In one embodiment, the processor is operable to establish a bidirectional communication between the one or more first vehicles 102 and the charging station 106. In one embodiment, the peer-to-peer connection comprises one of one-to-many connection, many-to-one connection, many-to-many connection and one-to-one connection. The P2P connection is configured to establish transferring or data and/or power (charge) between the charging station 106, the first vehicles 102, and the second vehicles 104. In one embodiment, the data comprises transfer of charge request message, discharge request message, status request or any other information between the charging station 106, the first vehicles 102, and the second vehicles 104.

In one embodiment, the charging station 106 receives the charge from the first vehicles 102 and charges the one or more first battery packs 107 of the charging station 106. The charging station 106 then transfers charge to the second vehicles 104 from the power stored in the one or more first battery packs 107 upon establishing connections/receiving charge requests from the second vehicles 104. In another embodiment, the charging station 106 receives the charge from the first vehicles 102 and directly distributes the power to the second vehicles 104.

How Technical Solution is a Technological Advancement: The technical solution enables addressing high charging demands without any delay either to the charging station or to the vehicles. The technical solution further enables both the entities (charging station and the vehicles) to donate excess available charge and make money. The technical solution further connects the entity with excess energy to the other entity which is draining out of charge. The technical solution by implementing the above strategies or schemes enables addressing of high charging demands.

In an aspect, a charging station is described. As an example, FIG. 2 illustrates a charging station, according to one or more embodiments. The charging station comprises: one or more first battery packs 202, a memory 204; and a processor 206. The one or more first battery packs 202 are electrically coupled to one or more power sources 208. The processor 206 is operable to determine whether a first state-of-charge of the one or more first battery packs is less than a threshold level (at step 203); determine whether one or more first vehicles are electrically coupled to the one or more first battery packs (at step 205); generate and communicate a first discharge request message to the one or more first vehicles (at step 207); receive a first response message from the one or more first vehicles (at step 209); and receive power from the one or more first vehicles based on the first response message (at step 211). In one embodiment, the processor 206 is operable to charge the one or more first battery packs using the power received from the one or more first vehicles. In another embodiment, the processor 206 is operable to directly distribute the power received from the one or more first vehicles to one or more second vehicles. In one embodiment, the one or more second vehicles are electrically coupled to the one or more first battery packs for charging the one or more second vehicles.

The processor 206 is operable to establish a peer-to-peer connection between the one or more first vehicles and one or more second vehicles through the charging station. In one embodiment, the peer-to-peer connection comprises one of one-to-many connection, many-to-one connection, many-to-many connection and one-to-one connection. In one embodiment, the processor is operable to establish a bidirectional communication between the one or more first vehicles and the charging station. In one embodiment, the processor is operable to establish a bidirectional communication between the one or more second vehicles and the charging station. In one embodiment, the charging station is coupled to the one or more first vehicles and one or more second vehicles through one of a wired connection and a wireless connection.

In one embodiment, the processor is operable to determine at least one of a state-of-charge, a state-of-health, and a charging specification of one or more second battery packs of the one or more first vehicles. In one embodiment, the processor is operable to generate the first discharge request message based on at least one of the state-of-charge, the state-of-health, and the charging specification of the one or more second battery packs of the one or more first vehicles. In one embodiment, the first discharge request message comprises information of at least one of a first required charge, a first monetary value, a charging station Identification number, a mode of charging, a scheduled time period, a charging duration, and a charging sequence. The processor of the charging station then receives the first response message in response to the discharge request message from the first vehicle. In one embodiment, the processor is operable to analyze the first response message and determine a first response from the one or more first vehicles. The first response comprises one of a confirmation, a negotiation, and a denial. In one embodiment, the processor is operable to receive the power from the one or more first vehicles upon determining the first response as the confirmation.

In one embodiment, the processor is operable to dynamically determine the first monetary value for a predefined time period based on a demand percentile score. In an embodiment, the processor utilizes the artificial intelligence engine to dynamically determine the first monetary value for a predefined time period based on a demand percentile score. The processor is operable to communicate an alert to the one or more first vehicles when the first monetary value is changed. The processor is further operable to communicate an alert to the one or more first vehicles when the first required charge is changed. In one embodiment, the processor is operable to communicate the alerts after receiving the response. In one embodiment, the first response message from the first vehicles comprises one of a negotiated first monetary value and a negotiated first required charge from the one or more first vehicles. The first response message may be a counter message to the request message. The counter message may comprise revised particulars/details in the request message. The counter message with the revised particulars may be agreed or approved by the charging station. The first vehicle starts discharging unless a subsequent request message (i.e., second discharge request message) is received for a predefined period. In one embodiment, the charging station may communicate a confirmation signal back to the first vehicles in response to the first response message. The first vehicle starts discharging upon receiving the confirmation signal.

In one embodiment, the processor is operable to generate a second discharge request message upon determining the first response as one of the negotiation and the denial. The second discharge request message comprises information of at least one of a second required charge, a second monetary value, a charging station Identification number, a mode of charging, a scheduled time period, a charging duration, and a charging sequence. In one embodiment, the processor is operable to receive a second response message in response to the second discharge request message. The processor is operable to analyze the second response message and determine a second response from the one or more first vehicles. The second response comprises one of a second confirmation, a second negotiation, and a second denial. The processor is operable to receive the power from the one or more first vehicles upon determining the second response as the second confirmation.

The processor is capable of analyzing and determining whether there are charging requests received from second vehicles. The processor is also capable of determining the first state-of-charge of the one or more first battery packs. In one embodiment, the processor is operable to determine a demand percentile score based on the one or more charge request messages from the one or more second vehicles and the first state-of-charge of the one or more first battery packs. The processor may comprise an artificial intelligence engine. In one embodiment, the artificial intelligence engine may reside in the cloud. The processor using the artificial intelligence engine may determine the demand percentile score by taking input as count of the charging requests and the first state-of-charge. The artificial intelligence engine is pre-trained using historical data. Based on the training provided, the artificial intelligence engine improves itself and determines the demand percentile score with better accuracy. In one embodiment, the processor is operable to dynamically generate the first discharge request message based on the demand percentile score in real-time. The processor is further operable to dynamically determine the first monetary value based on a demand percentile score in real-time. The artificial intelligence engine is pre-trained using historical data of monetary values based on demand percentile score. Based on the training provided, the artificial intelligence engine improves itself and determines the first monetary value with better accuracy.

The processor, upon receiving the power from the first vehicles, determines whether to charge the first battery packs of the charging station or to directly distribute the power to the second vehicles via the P2P connection. In one embodiment, the processor utilizes the artificial intelligence engine to determine whether to charge the first battery packs of the charging station or to directly distribute the power to the second vehicles via the P2P connection based on the demand percentile score. The processor, utilizing the artificial intelligence engine, may decide to charge the first battery packs of the charging station during night time. The processor, utilizing the artificial intelligence engine, may decide to directly distribute the power to the second vehicles during high demand.

The processor is then operable to receive one or more charge request messages from the one or more second vehicles. The processor then analyzes the charge request messages and discharges power accordingly to charge the one or more second vehicles. The processor is operable to charge the one or more second vehicles as per the charging specification of the second vehicles. The processor using the artificial intelligence may determine the make, the model, the charging specification, and other configuration of the electric vehicles (first vehicle, second vehicle) from an external database.

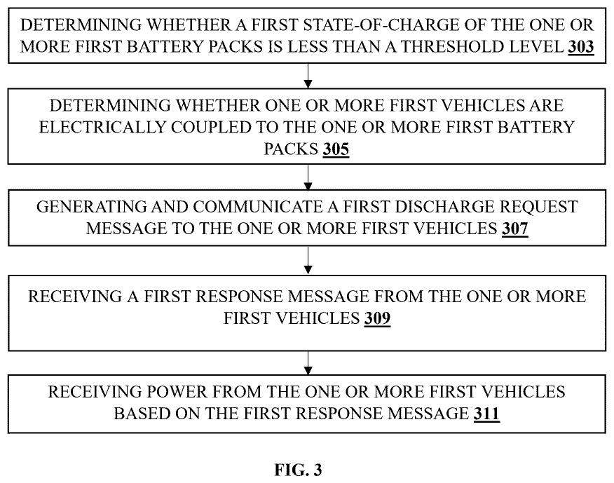

In one aspect, a method is described. As an example, FIG. 3 illustrates a method, according to one or more embodiments. The method comprises the following technical steps: determining whether a first state-of-charge of one or more first battery packs is less than a threshold level (at step 303); determining whether one or more first vehicles are electrically coupled to the one or more first battery packs (at step 305); generating and communicating a first discharge request message to the one or more first vehicles (at step 307); receiving a first response message from the one or more first vehicles (at step 309); and receiving power from the one or more first vehicles based on the first response message (at step 311). In one embodiment, the first discharge request message comprises information of at least one of a first required charge, a first monetary value, a charging station Identification number, a mode of charging, and a charging sequence.

The method further comprises: charging the one or more first battery packs using the power received from the one or more first vehicles. In one embodiment, the method further comprises: directly distributing the power received from the one or more first vehicles to one or more second vehicles.

In one embodiment, the method further comprises: establishing a peer-to-peer connection between the one or more first vehicles and one or more second vehicles through a charging station. The method further comprises: electrically coupling the one or more second vehicles to the one or more first battery packs for charging the one or more second vehicles. In one embodiment, the peer-to-peer connection comprises one-to-many connection, many-to-one connection, many-to-many connection and one-to-one connection. In one embodiment, the method further comprises: establishing a bidirectional communication between the one or more first vehicles and the charging station. In another embodiment, the method further comprises: establishing a bidirectional communication between the one or more second vehicles and the charging station. In one embodiment, the method further comprises: coupling a charging station to the one or more first vehicles and one or more second vehicles through one of a wired connection and a wireless connection.

The method further comprises: determining at least one of a state-of-charge, a state-of-health, and a charging specification of one or more second battery packs of the one or more first vehicles. In one embodiment, the method further comprises: generating the first discharge request message based on at least one of the state-of-charge, the state-of-health, and the charging specification of the one or more second battery packs of the one or more first vehicles.

The method further comprises: analyzing the first response message and determining a first response from the one or more first vehicles. In one embodiment, the first response comprises one of a confirmation, a negotiation, and a denial. In one embodiment, the method further comprises: receiving the power from the one or more first vehicles upon determining the first response as the confirmation. The first response message comprises one of a negotiated first monetary value and a negotiated first required charge from the one or more first vehicles. The first response message may be a counter message. The counter message may have revised particulars/etails of the request message.

In another embodiment, the method further comprises: generating a second discharge request message upon determining the first response as one of the negotiation and the denial. In one embodiment, the second discharge request message comprises information of at least one of a second required charge, a second monetary value, a charging station Identification number, a mode of charging, a scheduled time period, a charging duration, and a charging sequence. The method further comprises: receiving a second response message in response to the second discharge request message.

In one embodiment, the method further comprises: analyzing the second response message and determining a second response from the one or more first vehicles. The second response comprises one of a second confirmation, a second negotiation, and a second denial. In one embodiment, the method further comprises: receiving the power from the one or more first vehicles upon determining the second response as the second confirmation. In one embodiment, the method further comprises: receiving one or more charge request messages from the one or more second vehicles.

The method further comprises: determining a demand percentile score based on the first state-of-charge of the one or more first battery packs and the one or more charge request messages from the one or more second vehicles. In one embodiment, the method further comprises: dynamically generating the first discharge request message based on the demand percentile score in real-time. The method further comprises: dynamically determining the first monetary value based on a demand percentile score in real-time. In one embodiment, the method further comprises: dynamically determining the first monetary value for a predefined time period based on a demand percentile score.

In one embodiment, the method further comprises: communicating an alert to the one or more first vehicles when the first monetary value is changed. In one embodiment, the method further comprises: communicating an alert to the one or more first vehicles when the first required charge is changed.

In one aspect, a non-transitory computer readable storage medium is described. As an example, FIG. 4 illustrates a non-transitory computer readable storage medium, according to one or more embodiments. The non-transitory computer readable storage medium comprising a sequence of instructions, which when executed by a processor causes to execute the following technical steps: determining whether a first state-of-charge of one or more first battery packs is less than a threshold level (at step 403); determining whether one or more first vehicles are electrically coupled to the one or more first battery packs (at step 405); generating and communicating a first discharge request message to the one or more first vehicles (at step 407); receiving a first response message from the one or more first vehicles (at step 409); and receiving power from the one or more first vehicles based on the first response message (at step 411). In one embodiment, the first discharge request message comprises information of at least one of a first required charge, a first monetary value, a charging station Identification number, a mode of charging, a scheduled time period, a charging duration, and a charging sequence. In one embodiment, the first response message comprises one of a negotiated first monetary value and a negotiated first required charge from the one or more first vehicles. In one embodiment, the non-transitory computer readable storage medium further causes: electrically coupling the one or more second vehicles to the one or more first battery packs for charging the one or more second vehicles.

In one embodiment, the non-transitory computer readable storage medium further causes: charging the one or more first battery packs using the power received from the one or more first vehicles. In another embodiment, the non-transitory computer readable storage medium further causes: directly distributing the power received from the one or more first vehicles to one or more second vehicles.

In one embodiment, the non-transitory computer readable storage medium further causes: establishing a peer-to-peer connection between the one or more first vehicles and one or more second vehicles through a charging station. In one embodiment, the peer-to-peer connection comprises one-to-many connection, many-to-one connection, many-to-many connection and one-to-one connection. In one embodiment, the non-transitory computer readable storage medium further causes: establishing a bidirectional communication between the one or more first vehicles and the charging station. In one embodiment, the non-transitory computer readable storage medium further causes: establishing a bidirectional communication between the one or more second vehicles and the charging station. In one embodiment, the non-transitory computer readable storage medium further causes: coupling a charging station to the one or more first vehicles and one or more second vehicles through one of a wired connection and a wireless connection.

In one embodiment, the non-transitory computer readable storage medium further causes: determining at least one of a state-of-charge, a state-of-health, and a charging specification of one or more second battery packs of the one or more first vehicles. The non-transitory computer readable storage medium further causes: generating the first discharge request message based on at least one of the state-of-charge, the state-of-health, and the charging specification of the one or more second battery packs of the one or more first vehicles.

In one embodiment, the non-transitory computer readable storage medium further causes: analyzing the first response message and determining a first response from the one or more first vehicles. The first response comprises one of a confirmation, a negotiation, and a denial. In one embodiment, the non-transitory computer readable storage medium further causes: receiving the power from the one or more first vehicles upon determining the first response as confirmation. In one embodiment, the non-transitory computer readable storage medium further causes: generating a second discharge request message upon determining the first response as one of negotiation and denial. The second discharge request message comprises information of at least one of a second required charge, a second monetary value, a charging station Identification number, a mode of charging, a scheduled time period, a charging duration, and a charging sequence. The non-transitory computer readable storage medium further causes: receiving a second response message in response to the second discharge request message. The non-transitory computer readable storage medium further causes: analyzing the second response message and determining a second response from the one or more first vehicles. In one embodiment, the second response comprises one of a second confirmation, a second negotiation, and a second denial. The non-transitory computer readable storage medium further causes: receiving the power from the one or more first vehicles upon determining the second response as the second confirmation.

In one embodiment, the non-transitory computer readable storage medium further causes: receiving one or more charge request messages from the one or more second vehicles.

In one embodiment, the non-transitory computer readable storage medium further causes: determining a demand percentile score based on the first state-of-charge of the one or more first battery packs and the one or more charge request messages from the one or more second vehicles. In one embodiment, the non-transitory computer readable storage medium further causes: dynamically generating the first discharge request message based on the demand percentile score in real-time. In one embodiment, the non-transitory computer readable storage medium further causes: dynamically determining the first monetary value based on a demand percentile score in real-time. In one embodiment, the non-transitory computer readable storage medium further causes: dynamically determining the first monetary value for a predefined time period based on a demand percentile score.

In one embodiment, the non-transitory computer readable storage medium further causes: communicating an alert to the one or more first vehicles when the first monetary value is changed. In one embodiment, the non-transitory computer readable storage medium further causes: communicating an alert to the one or more first vehicles when the first required charge is changed.

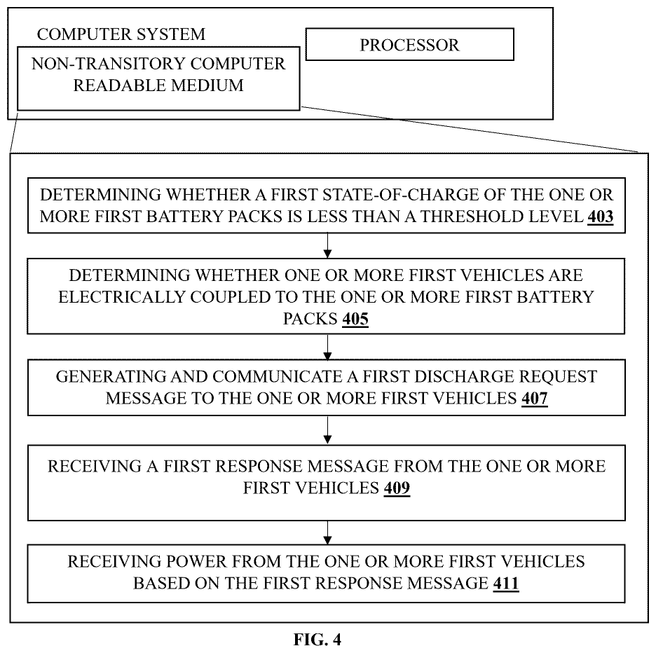

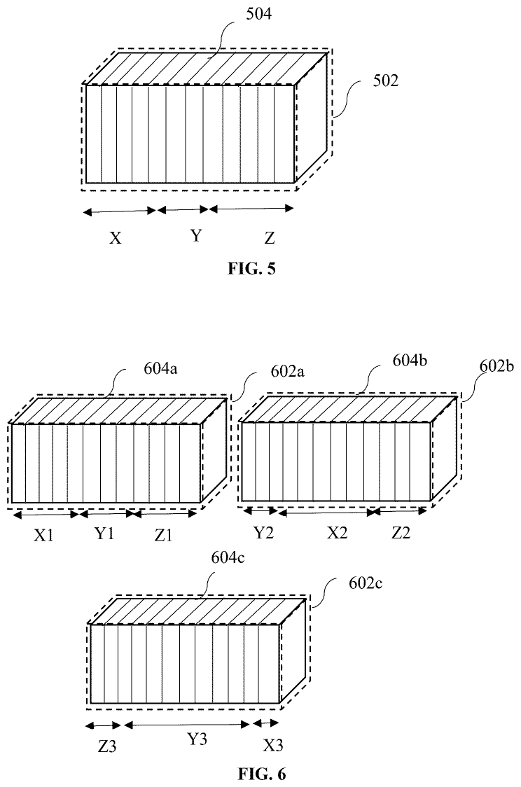

As an example, FIG. 5 illustrates a battery pack 502 comprising an individual battery, according to one or more embodiments. The battery pack 502 may be the battery within the charging station. In one embodiment, the battery pack 502 is within one of the first vehicle, and the second vehicle. The battery pack 502 within the charging station is stationary and large enough to supply power to charge multiple vehicles simultaneously. The battery within the charging station is huge when compared to the battery within the electric vehicles. The battery pack 502 herein comprises an individual battery. The battery comprises a plurality of cells 504. The battery pack comprises a first portion X, a second portion Y, and a third portion Z. The first portion X may comprise a first plurality of cells among the plurality of cells of the battery. The second portion Y may comprise a second plurality of cells among the plurality of cells of the battery. The third portion Z may comprise a third plurality of cells among the plurality of cells of the battery.

The first portion X, the second portion Y, and the third portion Z may be categorized based on the state-of-health information at the respective portions. The first portion X may comprise a first state-of-health. The second portion Y may comprise a second state-of-health. The third portion Z may comprise a third state-of-health. In an embodiment, the first portion may refer to a portion of the battery having degraded cells. The second portion may refer to a portion of the battery having healthy cells. The third portion may refer to a portion of the battery having moderate degraded cells. The processor may be configured to detect the state-of-charge of the battery pack 502 having at least one of healthy cells, degraded cells, and moderate degraded cells.

As an example, FIG. 6 illustrates a battery pack comprising a plurality of batteries, according to one or more embodiments. The battery pack herein comprises a first battery 602a, a second battery 602b, and a third battery 602c. The first battery 602a may comprise a plurality of first cells 604a. The second battery 602b may comprise a plurality of second cells 604b. The third battery 602c may comprise a plurality of third cells 604c. Each battery of the battery pack is connected electrically to get charged. The charging station charges each battery of the battery pack. The charging station may charge each battery of the battery pack through at least one of randomly, serially, and parallelly.

The charging station may charge at least one of a first portion X, a second portion Y, and a third portion Z of the battery pack. The first portion X of the battery pack refers to degraded cells from one or more batteries of the battery pack (X=X1+X2+X3). The second portion Y of the battery pack refers to healthy cells from one or more batteries of the battery pack (Y=Y1+Y2+Y3). The third portion Z of the battery pack refers to moderate degraded cells from one or more batteries of the battery pack (Z=Z1+Z2+Z3). Healthy cells may be contiguous or non-contiguously located within the same battery. Similarly, degraded, and moderate degraded cells may be contiguous or non-contiguously located within the same battery. In one embodiment, the charging station may charge in combination of degraded cells, healthy cells, and moderate degraded cells from the one or more batteries.

The charging station is configured to map the battery pack based on the state-of-health information. In an embodiment, the charging station maps at least one of the degraded cells, the healthy cells, and the moderate degraded cells of the battery pack. The charging station, upon performing mapping the battery pack, computes the state-of-charge considering the state-of-health information.

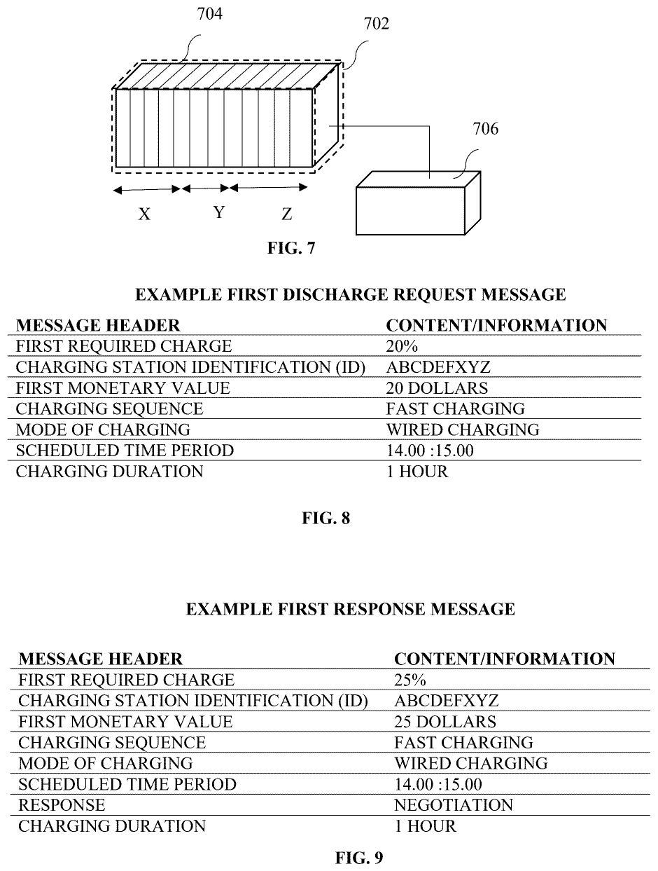

As an example, FIG. 7 schematically shows a battery pack comprising a battery 702 and a battery management system 706, according to one or more embodiments. The battery 702 in turn comprises a plurality of cells 704. The battery management system 706 may include a microprocessor, microcontroller, programmable digital signal processor, or another programmable device. The battery management system 706 may also or alternatively comprise an application specific integrated circuit, a programmable gate array or programmable array logic, a programmable logic device or a digital signal processor. Where the battery management system 706 comprises a programmable device such as the microprocessor, microcontroller or programmable digital signal processor mentioned above, the processor may also comprise computer executable code which controls the operation of the programmable device. In an embodiment, the battery management system 706 resides within an electric vehicle. The battery management system 706 determines the state-of-charge (SoC) of the battery pack and communicates to the charging station via a vehicle computer system.

As an example, FIG. 8 illustrates a first discharge request message, according to one or more embodiments. The first discharge message comprises fields such as at least a first required charge, a charging station identification number, a first monetary value, a charging sequence, a mode of charging, a scheduled time period, and a charging duration.

The charging station ID may be a serial identification number, or a tag associated with the charging station configured to identify, recognize, and locate the charging station. The charging sequence indicates a charging pattern by which the first battery packs of the charging station have to be charged using the power received from the first electric vehicle. The scheduled time period indicates a range of start time to end time of the charging session during which the charging station receives the power from the first electric vehicles. The charging duration refers to the total time for which the charging session is scheduled. The first required charge refers to the total amount of charge required for the first electric vehicle to reach the charging station and provides power to charge the first battery packs of the charging station. In one embodiment, the first required charge may also include the charge to complete an upcoming event in its itinerary. The first monetary value may refer to the cost estimated by the processor for receiving power from the electric vehicle in accordance with the demand percentile score. In an embodiment, the first discharge request message may comprise other particulars such as demand percentile score, charging date, charging session start time, charging session end time, etc. The first discharge request message is just like an enquiry sent by the charging station to electric vehicles requesting for power release from the electric vehicles to charge the first battery packs.

As an example, FIG. 9 illustrates a first response message, according to one or more embodiments. The first response message comprises fields such as at least a first required charge, a charging station identification number, a first monetary value, a charging sequence, a mode of charging, a scheduled time period, a response, and a charging duration.

The first response message comprises the same fields as described in FIG. 8. In addition to the fields illustrated in FIG. 9, the first response message comprises a response field. The response field may comprise values such as one of “confirmation”, “denial” and “negotiation”. In this example, the response field comprises the value as “negotiation”. The first response message may comprise same particulars of fields with revised values as contained within the first discharge request message when the response value is one of “negotiation” and “denial.” The first response message may also comprise same particulars of fields with same values as contained within the first discharge request message when the response value is “confirmation.” In an embodiment, the first response message may also comprise other particulars such as demand percentile score, charging date, charging session start time, charging session end time, etc. The first response message is just like a response message sent by the electric vehicles to charging stations either confirming, denying, or negotiating the offer enquired by the charging station. The user of the electric vehicles may negotiate with the charging station to obtain high monetary value.

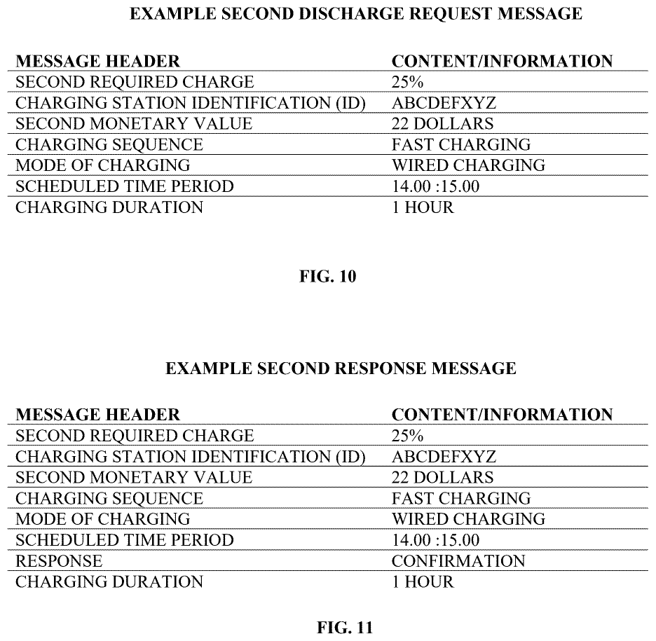

As an example, FIG. 10 illustrates a second discharge request message, according to one or more embodiments. The second discharge request message is sent subsequent to the first discharge request message when the response received from the electric vehicles is either “negotiation” or “denial”. The second discharge request message comprises fields such as at least a first required charge, a charging station identification number, a first monetary value, a charging sequence, a mode of charging, a scheduled time period, and a charging duration. The second discharge request message may comprise the above fields with revised values that may be acceptable to the electric vehicles. The second discharge request message is like a negotiation message (e.g., counter message with revised offer) sent in the second iteration.

The charging station ID may be a serial identification number, or a tag associated with the charging station configured to identify, recognize, and locate the charging station. The charging sequence indicates a charging pattern by which the first battery packs of the charging station have to be charged using the power received from the first electric vehicle. The scheduled time period indicates a range of start time to end time of the charging session during which the charging station receives the power from the first electric vehicles. The charging duration refers to the total time for which the charging session is scheduled. The second required charge refers to the total amount of charge required for the first electric vehicle to reach the charging station and provides power to charge the first battery packs of the charging station. In one embodiment, the second required charge may also include the charge to complete an upcoming event in its itinerary. The second monetary value may refer to the cost estimated by the processor for receiving power from the electric vehicle in accordance with the demand percentile score. In an embodiment, the second discharge request message may comprise other particulars such as demand percentile score, charging date, charging session start time, charging session end time, etc. The second discharge request message is just like an enquiry sent by the charging station to electric vehicles in second iteration requesting for power release from the electric vehicles to charge the first battery packs.

As an example, FIG. 11 illustrates a second response message, according to one or more embodiments. The second response message comprises fields such as at least a second required charge, a charging station identification number, a second monetary value, a charging sequence, a mode of charging, a scheduled time period, a response, and a charging duration.

The second response message comprises the same fields as described in FIG. 10. In addition to the fields illustrated in FIG. 10, the second response message comprises a response field. The response field may comprise values such as one of “confirmation”, “denial” and “negotiation”. In this example, the response field comprises the value as “negotiation”. The second response message may comprise same particulars of fields with revised values as contained within the second discharge request message when the response value is one of “negotiation” and “denial.” The second response message may also comprise same particulars of fields with same values as contained within the second discharge request message when the response value is “confirmation.” In an embodiment, the second response message may also comprise other particulars such as demand percentile score, charging date, charging session start time, charging session end time, etc. The second response message is just like a response message sent by the electric vehicles to charging stations either confirming, denying, or negotiating the offer enquired by the charging station. The user of the electric vehicles may negotiate with the charging station to obtain high monetary value.

Business problem 2: As most vehicles today are electric vehicles, there is no sufficient charging station to charge electric vehicles. The charging station may also run out of power to charge the vehicles. The charging station has to receive power from external sources to address charging demands.

Business Solution 2: The business solution implements a charging station with a stationary and large battery. The stationary battery enables the charging station to get charged during night time or during non-peak hours. The charging station looks for external power sources to charge the stationary battery of the charging station. The charging station may be capable of receiving power from other entities such as electric vehicles. However, if there are no entities at the locality of the charging station, the charging station looks for electric vehicles within a predefined geographical range that can provide charge to charging station. The charging station then broadcasts discharge request message to those vehicles. By implementing this solution, the stationary battery of the charging station may receive power from electric vehicles within the predefined geographical range.

Technical problem 2: As more and more cars become EV, more charging stations will be required. One type of charging station is emerging where there is a stationary battery that is connected to a grid that provides charge to multiple cars. The stationary battery is large and periodically charges using the grid, usually overnight or during non-peak usage. At these stations, the cars plug in as normal, and the cars are provided a charge directly from the stationary battery. However, during certain times of the day or year, the demand may be high and there may not be enough charge from the battery to satisfy the needs of multiple cars. Instead of draining the battery and rejecting the additional users, a smart scheme needs to be implemented to address high demands.

Technical solution 2: Here, when the charging station is running out of energy because the demand is high (too many cars plugged for charging) or anticipates running out of energy, the charging station broadcasts a message to cars with a geographical location (e.g., car nearby), that can assist. In an aspect, the charging station broadcasts a message to nearby cars when the energy for the stationary battery drops below a threshold. The message comprises a required charge, location of the charging station, the charging station number, available monetary value, amount of charge needed. The charging station receives a message accepting the offered terms or receives an indication that a new offer is provided by a specific vehicle. The system can aggregate the responses and provide a message directed to the specific car making the new offer.

Technical Result 2: The charging station communicates the discharge request message to electric vehicles within a predefined geographical range. The processor within the electric vehicle may analyze the discharge request message and either accepts, denies, or negotiates with the request message. The negotiation may go up to one or more iterations and finally may agree to the monetization opportunity. Upon receiving confirmation of the monetization opportunity, the charging station may receive charge from the electric vehicles within the predefined geographical range.

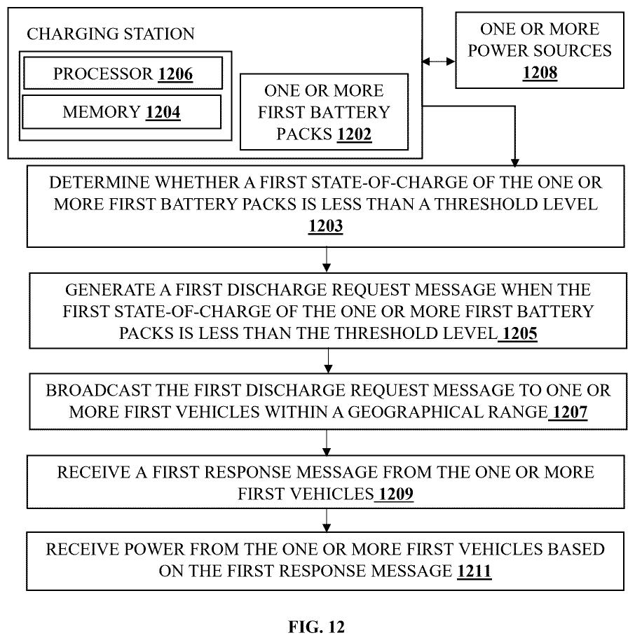

Technical Details specific to Technical Result: In an aspect, a charging station is described. As an example, FIG. 12 illustrates a charging station, according to one or more embodiments. The charging station comprises: one or more first battery packs 1202 that are electrically coupled to one or more power sources 1208; a memory 1204; and a processor 1206 that is communicatively coupled to the memory 1204. The processor 1206 is operable to determine whether a first state-of-charge of the one or more first battery packs 1202 is less than a threshold level (at step 1203); generate a first discharge request message when the first state-of-charge of the one or more first battery packs is less than the threshold level (at step 1205); broadcast the first discharge request message to one or more first vehicles within a geographical range (at step 1207); receive a first response message from the one or more first vehicles (at step 1209); and receive power from the one or more first vehicles based on the first response message (at step 1211). In one embodiment, the processor is operable to charge the one or more first battery packs 1202 using the power received from the one or more first vehicles. In another embodiment, the processor is operable to directly distribute the power received from the one or more first vehicles to one or more second vehicles.

In one embodiment, the processor is operable to establish a peer-to-peer connection between the one or more first vehicles and one or more second vehicles through the charging station. In one embodiment, the peer-to-peer connection comprises one of one-to-many connection, many-to-one connection, many-to-many connection and one-to-one connection. In one embodiment, the processor is operable to establish a bidirectional communication between the one or more first vehicles and the charging station. In one embodiment, the processor is operable to establish a bidirectional communication between the one or more second vehicles and the charging station. In one embodiment, the one or more second vehicles are electrically coupled to the one or more first battery packs for charging the one or more second vehicles.

In one embodiment, the processor is operable to determine at least one of a state-of-charge, a state-of-health, and a charging specification of one or more second battery packs of the one or more first vehicles. In one embodiment, the processor is operable to generate the first discharge request message based on at least one of the state-of-charge, the state-of-health, and the charging specification of the one or more second battery packs of the one or more first vehicles. The first discharge request message comprises information of at least one of a first required charge, a first monetary value, a charging station identification number, a mode of charging, a location of charging station, an amount of charging needed, a scheduled time period, a charging duration, and a charging sequence.

The processor is operable to analyze the first response message and determine a first response from the one or more first vehicles. The first response comprises one of confirmation, negotiation, and denial. In one embodiment, the processor is operable to receive the power from the one or more first vehicles upon determining the first response as the confirmation. In one embodiment, the processor is operable to generate a second discharge request message upon determining the first response as one of the negotiation and the denial. In one embodiment, the first response as the negotiation comprises information of at least one of a second required charge, and a second monetary value. The second discharge request message comprises information of at least one of a second required charge, a second monetary value, a charging station Identification number, a mode of charging, a location of charging station, an amount of charging needed, a scheduled time period, a charging duration, and a charging sequence.

In one embodiment, the processor is operable to establish a bidirectional communication with one or more third vehicles that randomly arrives at the charging station. The processor is operable to communicate the first discharge request message to the one or more third vehicles. The processor is operable to receive the first response message from the one or more third vehicles. In one embodiment, the processor is operable to receive the power from the one or more third vehicles upon receiving confirmation from the one or more third vehicles.

How Technical Solution is a Technological Advancement: The technical solution enables addressing high charging demands without any delay either to the charging station or to the vehicles. The technical solution further enables both the entities (charging station and the vehicles) to donate excess available charge and make money. The technical solution further connects the entity with excess energy to the other entity which is draining out of charge. The technical solution by implementing the above strategies or schemes enables addressing of high charging demands.

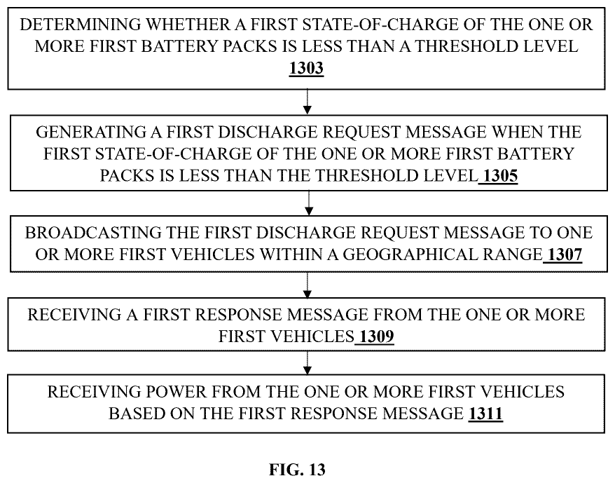

In another aspect, a method is described. As an example, FIG. 13 illustrates a method, according to one or more embodiments. The method comprises: determining whether a first state-of-charge of one or more first battery packs is less than a threshold level (at step 1303); generating a first discharge request message when the first state-of-charge of the one or more first battery packs is less than the threshold level (at step 1305); broadcasting the first discharge request message to one or more first vehicles within a geographical range (at step 1307); receiving a first response message from the one or more first vehicles (at step 1309); and receiving power from the one or more first vehicles based on the first response message (at step 1311). In one embodiment, the method further comprises: charging the one or more first battery packs using the power received from the one or more first vehicles. In one embodiment, the method further comprises: directly distributing the power received from the one or more first vehicles to one or more second vehicles.

In one embodiment, the method further comprises: establishing a peer-to-peer connection between the one or more first vehicles and one or more second vehicles through a charging station. In one embodiment, the peer-to-peer connection comprises one of one-to-many connection, many-to-one connection, many-to-many connection and one-to-one connection. In one embodiment, the method further comprises: establishing a bidirectional communication between the one or more first vehicles and the charging station. In one embodiment, the method further comprises: establishing a bidirectional communication between the one or more second vehicles and the charging station. In one embodiment, the method further comprises: electrically coupling the one or more second vehicles to the one or more first battery packs for charging the one or more second vehicles.

In one embodiment, the method further comprises: determining at least one of a state-of-charge, a state-of-health, and a charging specification of one or more second battery packs of the one or more first vehicles. The method further comprises: generating the first discharge request message based on at least one of the state-of-charge, the state-of-health, and the charging specification of the one or more second battery packs of the one or more first vehicles. In one embodiment, the first discharge request message comprises information of at least one of a first required charge, a first monetary value, a charging station identification number, a mode of charging, a location of charging station, an amount of charging needed, a scheduled time period, a charging duration, and a charging sequence.

In one embodiment, the method further comprises: analyzing the first response message and determining a first response from the one or more first vehicles. In one embodiment, the first response comprises one of confirmation, negotiation, and denial. In one embodiment, the method further comprises: receiving the power from the one or more first vehicles upon determining the first response as the confirmation. In one embodiment, the first response as the negotiation comprises information of at least one of a second required charge, and a second monetary value. In one embodiment, the method further comprises: generating a second discharge request message upon determining the first response as one of the negotiation and the denial. The second discharge request message comprises information of at least one of a second required charge, a second monetary value, a charging station Identification number, a mode of charging, a location of charging station, an amount of charging needed, a scheduled time period, a charging duration, and a charging sequence.

In one embodiment, the method further comprises: establishing a bidirectional communication with one or more third vehicles that randomly arrives at a charging station. In one embodiment, the method further comprises: communicating the first discharge request message to the one or more third vehicles. In one embodiment, the method further comprises: receiving the first response message from the one or more third vehicles. In one embodiment, the method further comprises: receiving the power from the one or more third vehicles upon receiving confirmation from the one or more third vehicles.

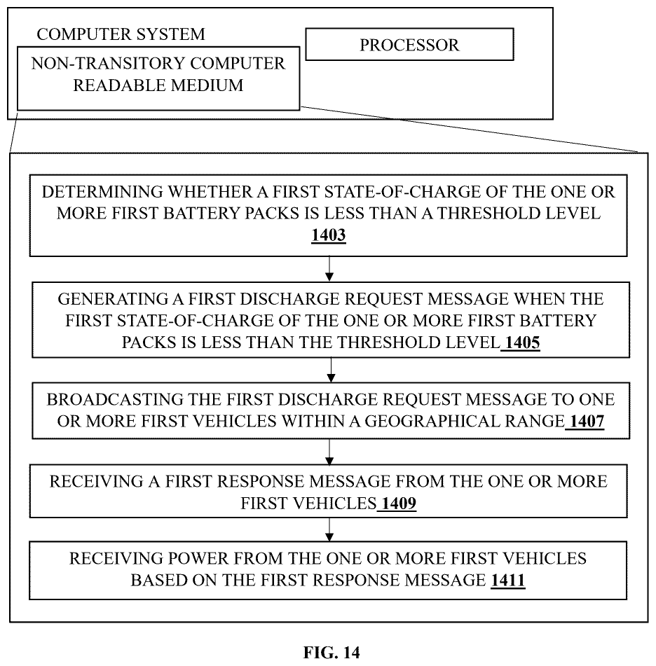

In one aspect, a non-transitory computer readable storage medium is described. As an example, FIG. 14 illustrates a non-transitory computer readable storage medium, according to one or more embodiments. The non-transitory computer readable storage medium comprising a sequence of instructions, which when executed by a processor causes: determining whether a first state-of-charge of one or more first battery packs is less than a threshold level (at step 1403); generating a first discharge request message when the first state-of-charge of the one or more first battery packs is less than the threshold level (at step 1405); broadcasting the first discharge request message to one or more first vehicles within a geographical range (at step 1407); receiving a first response message from the one or more first vehicles (at step 1409); and receiving power from the one or more first vehicles based on the first response message (at step 1411). The non-transitory computer readable storage medium further causes: charging the one or more first battery packs using the power received from the one or more first vehicles. In one embodiment, the non-transitory computer readable storage medium further causes: directly distributing the power received from the one or more first vehicles to one or more second vehicles.

In one embodiment, the non-transitory computer readable storage medium further causes: establishing a peer-to-peer connection between the one or more first vehicles and one or more second vehicles through a charging station. The non-transitory computer readable storage medium further causes: electrically coupling the one or more second vehicles to the one or more first battery packs for charging the one or more second vehicles. In one embodiment, the peer-to-peer connection comprises one of one-to-many connection, many-to-one connection, many-to-many connection and one-to-one connection. In one embodiment, the non-transitory computer readable storage medium further causes: establishing a bidirectional communication between the one or more first vehicles and the charging station. The non-transitory computer readable storage medium further causes: establishing a bidirectional communication between the one or more second vehicles and the charging station.

In one embodiment, the non-transitory computer readable storage medium further causes: determining at least one of a state-of-charge, a state-of-health, and a charging specification of one or more second battery packs of the one or more first vehicles. In one embodiment, the non-transitory computer readable storage medium further causes: generating the first discharge request message based on at least one of the state-of-charge, the state-of-health, and the charging specification of the one or more second battery packs of the one or more first vehicles. The first discharge request message comprises information of at least one of a first required charge, a first monetary value, a charging station identification number, a mode of charging, a location of charging station, an amount of charging needed, a scheduled time period, a charging duration, and a charging sequence.

In one embodiment, the non-transitory computer readable storage medium further causes: analyzing the first response message and determining a first response from the one or more first vehicles. The first response comprises one of confirmation, negotiation, and denial. In one embodiment, the non-transitory computer readable storage medium further causes: receiving the power from the one or more first vehicles upon determining the first response as the confirmation.

In one embodiment, the non-transitory computer readable storage medium further causes: generating a second discharge request message upon determining the first response as one of the negotiation and the denial. The second discharge request message comprises information of at least one of a second required charge, a second monetary value, a charging station Identification number, a mode of charging, a location of charging station, an amount of charging needed, a scheduled time period, a charging duration, and a charging sequence. In one embodiment, the first response as the negotiation comprises information of at least one of a second required charge, and a second monetary value.

In one embodiment, the non-transitory computer readable storage medium further causes: establishing a bidirectional communication with one or more third vehicles that randomly arrives at a charging station. The non-transitory computer readable storage medium further causes: communicating the first discharge request message to the one or more third vehicles. The non-transitory computer readable storage medium further causes: receiving the first response message from the one or more third vehicles. The non-transitory computer readable storage medium further causes: receiving the power from the one or more third vehicles upon receiving confirmation from the one or more third vehicles.

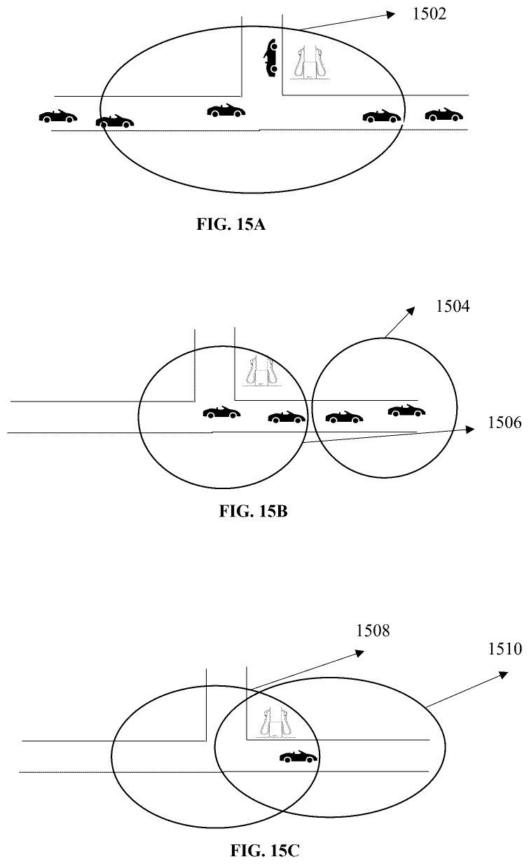

As an example, FIG. 15A illustrates a charging station broadcasting the discharge request message to electric vehicles with a predefined geographical range, according to one or more embodiments. The charging station comprises a Global Positioning System (GPS) that determines a current location of the charging station. The processor, via the GPS, monitors vehicles within the predefined geographical range 1502. The processor may preset extent of the predefined geographical range.

The processor, via the GPS, tracks and monitors the location of the vehicles when the vehicles enter into the predefined geographical range 1502. The processor then establishes connection with the vehicles. The connection may be a peer-to-peer connection. Once the connection is established, the processor establishes communication with the vehicles. The connection may also be adapted to establish power transfer (e.g. charge) between the vehicles and the charging station. The processor may also extract details such as state-of-charge, state-of health, charging specification, etc., from the vehicles. The processor of the charging station then broadcasts the first discharge request message to the vehicles within the predefined geographical range 1502. The vehicles may respond with a first response message. The first response message may comprise a first response. The first response comprises one of a confirmation, a denial, and a negotiation.

The vehicles may send confirmation as the first response to the charging station. The charging station then may receive power from the vehicles. The vehicles may also send negotiation as the first response with a counter message (first response message). In that case, the charging station analyzes the first response message and generates a second discharge request message. The vehicles then may provide confirmation as the second response message. The charging station then may receive power from the vehicles upon receiving the confirmation. The vehicles may also send denial as the first response with a counter message (first response message). In that case, the charging station may send the discharge request message to other vehicles.

As an example, FIG. 15B illustrates a charging station broadcasting the discharge request message to electric vehicles with a predefined geographical range having non-contiguous zones 1504 and 1506, according to one or more embodiments. The processor using the GPS tracks the vehicles within the predefined geographical range and clusters them into zones. The vehicles may be clustered into separate non-contiguous zones 1504 and 1506 based on the location of the vehicles within the predefined geographical range. As an example, FIG. 15C illustrates a charging station broadcasting the discharge request message to electric vehicles with a predefined geographical range having contiguous zones 1508 and 1510, according to one or more embodiments. The processor using the GPS tracks the vehicles within the predefined geographical range and clusters them into zones. The vehicles may be clustered into separate contiguous zones 1508 and 1510 based on the location of the vehicles within the predefined geographical range. The predefined geographical range is split into contiguous zones 1508 and 1510 when the vehicles are closely located within the predefined geographical range.

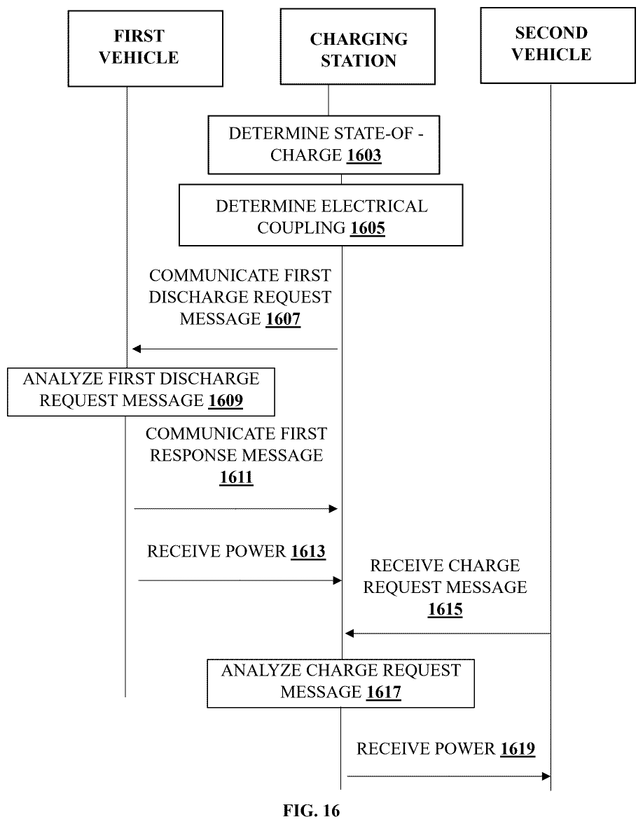

As an example, FIG. 16 illustrates a communication flow between a charging station, a first vehicle, and a second vehicle, according to one or more embodiments. The charging station establishes a peer-to-peer connection between the charging station, the first vehicle, and the second vehicle. The peer-to-peer connection enables data transfer and power transfer between the charging station, the first vehicle, and the second vehicle.

At step 1603, the charging station determines whether a first state-of-charge of the one or more first battery packs is less than a threshold level. At step 1605, the charging station determines whether one or more first vehicles are electrically coupled to the one or more first battery packs. At step 1607, the charging station communicates a first discharge request message to the first vehicle. At step 1609, the first vehicle analyzes the first discharge request message. At step 1611, the first vehicle communicates the first response message. At step 1613, the charging station may receive power from the first vehicle based on the first response message. At step 1615, the charging station may receive a charge request message from the second vehicle. At step 1617, the charging station analyzes the charge request message. At step 1619, the charging station provides power to the second vehicle to charge the battery packs of the second vehicle.

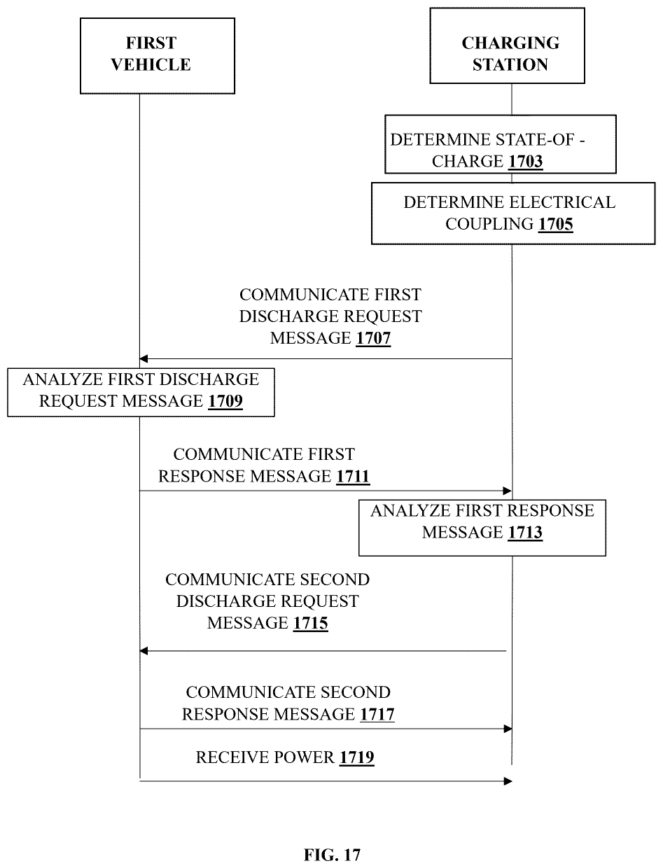

As an example, FIG. 17 illustrates a communication flow between a charging station, and a first vehicle, according to one or more embodiments. The charging station establishes a peer-to-peer connection between the charging station, and the first vehicle. The peer-to-peer connection enables data transfer and power transfer between the charging station and the first vehicle. The peer-to-peer connection establishes a bidirectional communication between the charging station and the first vehicle.

At step 1703, the charging station determines whether a first state-of-charge of the one or more first battery packs is less than a threshold level. At step 1705, the charging station determines whether one or more first vehicles are electrically coupled to the one or more first battery packs. At step 1707, the charging station communicates a first discharge request message to the first vehicle. At step 1709, the first vehicle analyzes the first discharge request message. At step 1711, the first vehicle communicates the first response message to the charging station. At step 1713, the charging station may analyze the first response message and generate the second discharge request message. At step 1715, the charging station communicates the second discharge request message to the first vehicle. At step 1717, the first vehicle communicates the second response message to the charging station. At step 1719, the charging station may receive power from the first vehicle based on the first response message.

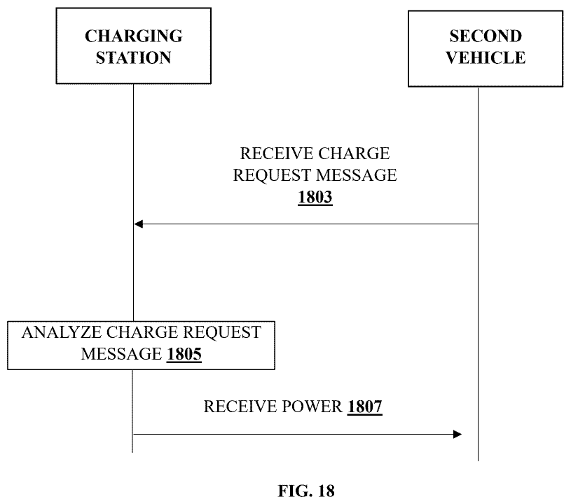

As an example, FIG. 18 illustrates a communication flow between a charging station, and a second vehicle, according to one or more embodiments. At step 1803, the charging station may receive a charge request message from a second vehicle. At step 1805, the charging station analyzes the charge request message. In an embodiment, the charging station determines whether a first state-of-charge of the one or more first battery packs is less than a threshold level. At step 1807, the charging station provides power to the second vehicle to charge the battery packs of the second vehicle upon determining that the first state-of-charge of the one or more first battery packs is greater than the threshold level.

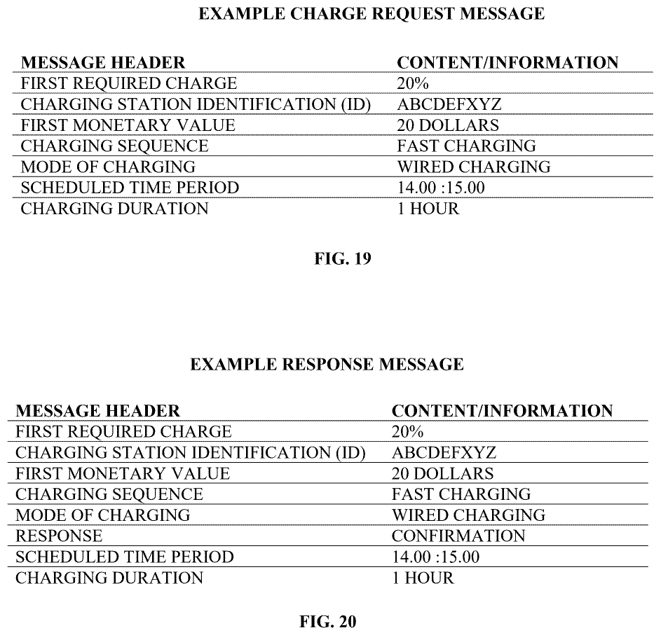

As an example, FIG. 19 illustrates a charge request message sent by a second vehicle to a charging station, according to one or more embodiments. The charge request message comprises fields such as at least a first required charge, a charging station identification number, a first monetary value, a charging sequence, a mode of charging, a scheduled time period, and a charging duration.

The charging station ID may be a serial identification number, or a tag associated with the charging station configured to identify, recognize, and locate the charging station. The charging sequence indicates a charging pattern by which the battery packs of the second vehicle have to be charged. The scheduled time period indicates a range of start time to end time of the charging session during which the second vehicle receives the power from the charging station. The charging duration refers to the total time for which the charging session is scheduled. The first required charge refers to the total amount of charge required for the second vehicle to get charged. The first monetary value may refer to the cost estimated for receiving power from the charging station in accordance with the demand percentile score. In an embodiment, the charge request message may comprise other particulars such as demand percentile score, charging date, charging session start time, charging session end time, etc. The charge request message is just like an enquiry sent by the second electric vehicles to the charging station requesting for power release from the charging station to charge the second vehicle.

As an example, FIG. 20 illustrates a response message sent by a charging station to a second vehicle, according to one or more embodiments. The response message comprises fields such as at least a first required charge, a charging station identification number, a first monetary value, a charging sequence, a mode of charging, a scheduled time period, a response, and a charging duration.

The response message comprises the same fields as described in FIG. 19. In addition to the fields illustrated in FIG. 19, the response message comprises a response field. The response field may comprise values such as one of “confirmation”, “denial” and “negotiation”. In this example, the response field comprises the value as “confirmation”. The response message may comprise same particulars of fields with revised values as contained within the charge request message when the response value is one of “negotiation” and “denial.” The response message may also comprise same particulars of fields with same values as contained within the charge request message when the response value is “confirmation.” In an embodiment, the response message may also comprise other particulars such as demand percentile score, charging date, charging session start time, charging session end time, etc. The response message is just like a response message sent by the charging station to electric vehicles either confirming, denying, or negotiating the offer enquired by the electric vehicles.

Business problem 3: As most vehicles today are electric vehicles, there is no sufficient charging station to charge electric vehicles. The charging station may also run out of power to charge the vehicles. The charging station has to receive power from external sources to address charging demands.

Business Solution 3: The business solution implements a charging station with a stationary and large battery. The processor of the charging station may communicate discharge requests to the electric vehicles. The vehicle, upon receiving the discharge requests from the charging station, determines the available energy within the vehicle. Upon determining the available energy, the monetization opportunity to offer charging to the charging station is displayed onto the dashboard. Upon confirmation, the optimized route is displayed to reach the charging station and provide charge.

Technical problem 3: As more and more cars become EV, more charging stations will be required. One type of charging station is emerging where there is a stationary battery that is connected to a grid that provides charge to multiple cars. The stationary battery is large and periodically charges using the grid, usually overnight or during non-peak usage. At these stations, the cars plug in as normal, and the cars are provided a charge directly from the stationary battery. However, during certain times of the day or year, the demand may be high and there may not be enough charge from the battery to satisfy the needs of multiple cars. Instead of draining the battery and rejecting the additional users, a smart scheme needs to be implemented to address high demands.

Technical solution 3: In an aspect, the car is configured to receive and process the broadcast message. The system in the car determines if resources are available to assist by checking various factors, such as available energy based on scheduled trip information (e.g., how much energy does the car need for itself based on predicted use, such as charge needed to reach a destination). If determined that there is available energy to discharge, the system alerts the driver by displaying location of the charging station and opportunity to monetize as the monetary value is provided in the broadcasted message. If the user accepts the terms, the system identifies the most efficient route and possible things to do at or near the location of the charging station. In an aspect, the user can negotiate with the charging station using a response message indicating a new offer.

Technical Result: The electric vehicle analyzes the discharge request message from the charging station. The processor within the electric vehicle determines that the electric vehicle has a state-of-charge greater than the threshold level (more than its requirement). Upon determining, the processor depicts the offer to sell the charge. The processor upon receiving confirmation from the user, depicts the location of the charging station and navigates via the optimized route to reach the charging station to give charge and earn money.

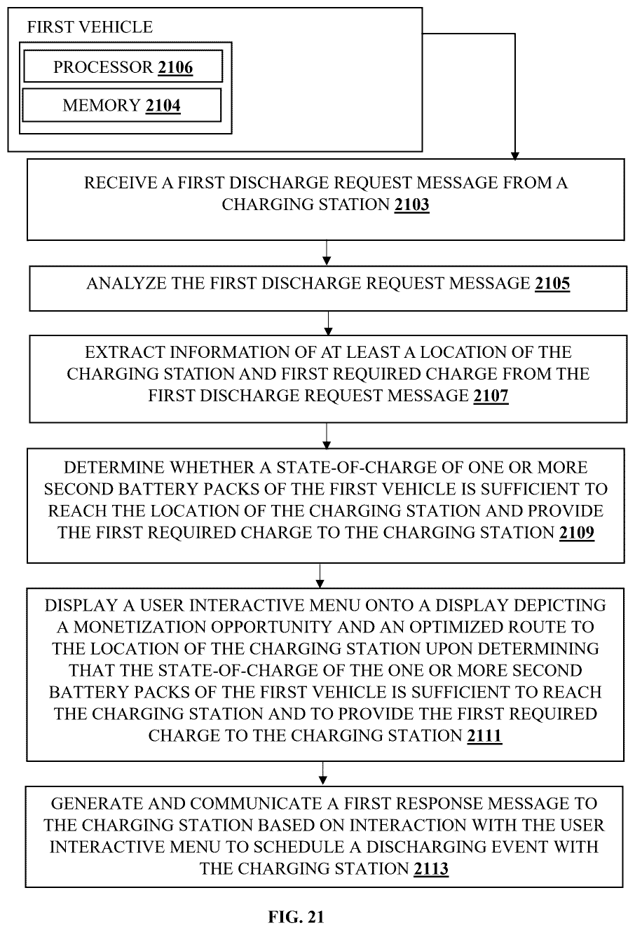

Technical Details specific to Technical Result: In an aspect, a first vehicle is described. As an example, FIG. 21 illustrates a first vehicle, according to one or more embodiments. The first vehicle comprises: a memory 2104; and a processor 2106 that is communicatively coupled to the memory 2104. The processor 2106 is operable to receive a first discharge request message from a charging station (at step 2103); analyze the first discharge request message (at step 2105); extract information of at least a location of the charging station and first required charge from the first discharge request message (at step 2107); determine whether a state-of-charge of one or more second battery packs of the first vehicle is sufficient to reach the location of the charging station and provide the first required charge to the charging station (at step 2109); display a user interactive menu onto a display depicting a monetization opportunity and an optimized route to the location of the charging station upon determining that the state-of-charge of the one or more second battery packs of the first vehicle is sufficient to reach the charging station and to provide the first required charge to the charging station (at step 2111); and generate and communicate a first response message to the charging station based on interaction with the user interactive menu to schedule a discharging event with the charging station (at step 2113). In one embodiment, the processor is operable to determine a state-of-health, a charging specification, a charging duration, and a charging sequence of the one or more second battery packs of the first vehicle. In one embodiment, the processor is operable to establish a peer-to-peer connection between the first vehicle and the charging station.

In one embodiment, the processor is operable to determine an itinerary information of the first vehicle from one or more databases. The first discharge request message comprises information of at least one of the first required charge, a first monetary value, a charging station identification number, a mode of charging, the location of the charging station, an amount of charging needed, a scheduled time period, a charging duration, and a charging sequence. In one embodiment, the processor is operable to generate the first response message based on user interactions with the user interactive menu. The first response message comprises a first response as one of a confirmation, a negotiation, and a denial. In one embodiment, the processor is operable to transmit power to the charging station upon sending the first response as the confirmation. The first response message comprises a counter message that comprises revised information of at least one of the first required charge, the first monetary value, the charging station identification number, the mode of charging, the location of the charging station, the amount of charging needed, the scheduled time period, the charging duration, and the charging sequence.

In one embodiment, the processor is operable to receive a second discharge request message from the charging station upon sending the first response as one of a negotiation and a denial. In one embodiment, the processor is operable to receive one or more user inputs to provide user instructions with the user interactive menu from one of an external device and a dashboard.

How Technical Solution is a Technological Advancement: The technical solution enables addressing high charging demands without any delay either to the charging station or to the vehicles. The technical solution further enables both the entities (charging station and the vehicles) to donate excess available charge and make money. The technical solution further connects the entity with excess energy to the other entity which is draining out of charge. The technical solution by implementing the above strategies or schemes enables addressing of high charging demands.

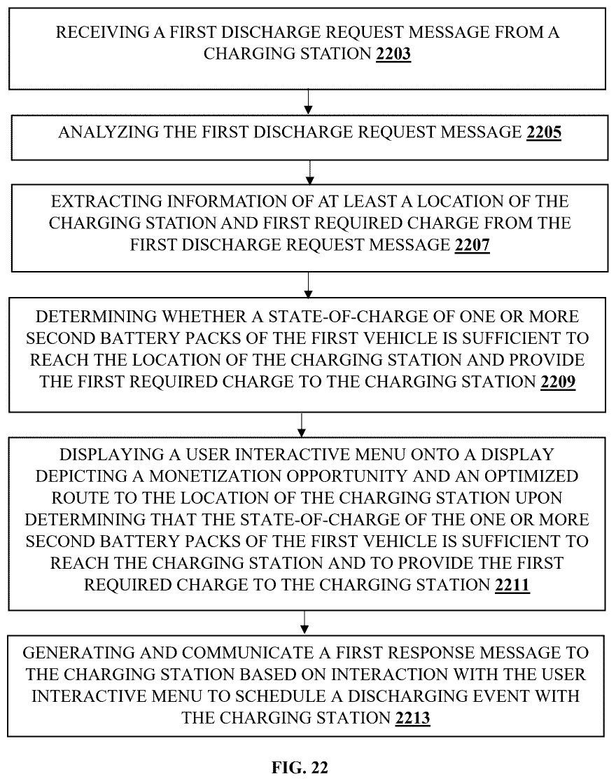

In one aspect, a method is described. As an example, FIG. 22 illustrates a method, according to one or more embodiments. The method comprises: receiving a first discharge request message from a charging station (at step 2203); analyzing the first discharge request message (at step 2205); extracting information of at least a location of the charging station and first required charge from the first discharge request message (at step 2207); determining whether a state-of-charge of one or more second battery packs of a first vehicle is sufficient to reach the location of the charging station and provide the first required charge to the charging station (at step 2209); displaying a user interactive menu onto a display depicting a monetization opportunity and an optimized route to the location of the charging station upon determining that the state-of-charge of the one or more second battery packs of the first vehicle is sufficient to reach the charging station and to provide the first required charge to the charging station (at step 2211); and generating and communicating a first response message to the charging station based on interaction with the user interactive menu to schedule a discharging event with the charging station (at step 2213).

In one embodiment, the method further comprises: determining a state-of-health, a charging specification, a charging duration, and a charging sequence of the one or more second battery packs of the first vehicle. In one embodiment, the method further comprises: determining an itinerary information of the first vehicle from one or more databases. The itinerary information may be used to determine the amount of charge to be provided to the charging station.

In one embodiment, the method further comprises: generating the first response message based on user interactions with the user interactive menu. In one embodiment, the method further comprises: establishing a peer-to-peer connection between the first vehicle and the charging station.

In one embodiment, the first discharge request message comprises information of at least one of the first required charge, a first monetary value, a charging station identification number, a mode of charging, the location of the charging station, an amount of charging needed, a scheduled time period, a charging duration, and a charging sequence. In one embodiment, the first response message comprises a first response as one of a confirmation, a negotiation, and a denial. The first response message comprises a counter message that comprises revised information of at least one of the first required charge, the first monetary value, the charging station identification number, the mode of charging, the location of the charging station, the amount of charging needed, the charging duration, the scheduled time period and the charging sequence.

In one embodiment, the method further comprises: transmitting power to the charging station upon sending the first response as the confirmation. In one embodiment, the method further comprises: receiving a second discharge request message from the charging station upon sending the first response as one of the negotiation and the denial.

In one embodiment, the first response message comprises a counter message that comprises revised information of at least one of the first required charge, the first monetary value, the charging station identification number, the mode of charging, the location of the charging station, the amount of charging needed, the charging duration, the scheduled time period and the charging sequence. In one embodiment, the method further comprises: receiving one or more user inputs to provide user instructions with the user interactive menu from one of an external device and a dashboard.

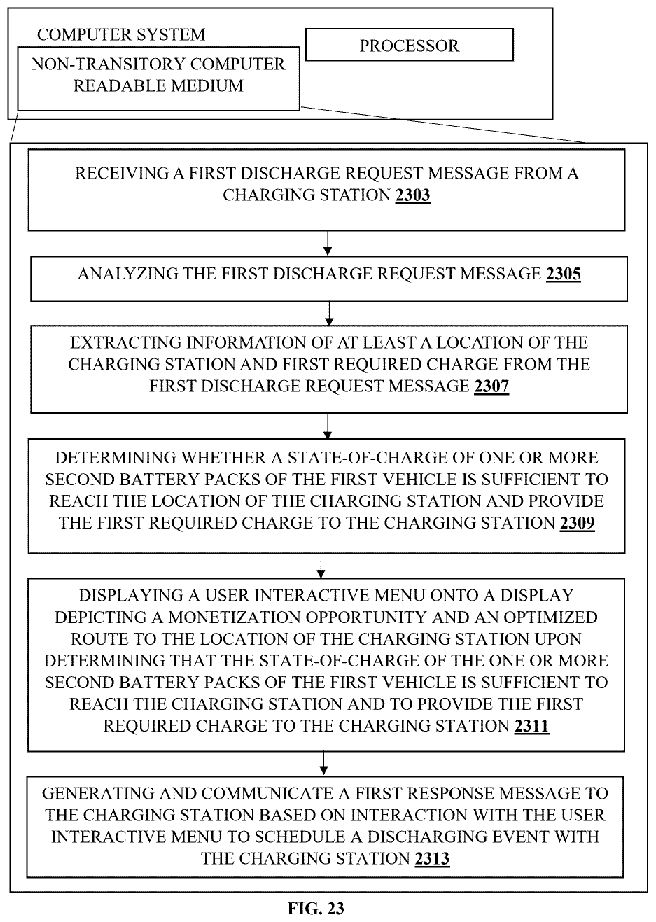

In one aspect, a non-transitory computer readable storage medium is described. As an example, FIG. 23 illustrates a non-transitory computer readable storage medium, according to one or more embodiments. The non-transitory computer readable storage medium comprising a sequence of instructions, which when executed by a processor causes: receiving a first discharge request message from a charging station (at step 2303); analyzing the first discharge request message (at step 2305); extracting information of at least a location of the charging station and first required charge from the first discharge request message (at step 2307); determining whether a state-of-charge of one or more second battery packs of a first vehicle is sufficient to reach the location of the charging station and provide the first required charge to the charging station (at step 2309); displaying a user interactive menu onto a display depicting a monetization opportunity and an optimized route to the location of the charging station upon determining that the state-of-charge of the one or more second battery packs of the first vehicle is sufficient to reach the charging station and to provide the first required charge to the charging station (at step 2311); and generating and communicating a first response message to the charging station based on interaction with the user interactive menu to schedule a discharging event with the charging station (at step 2313).

In one embodiment, the non-transitory computer readable storage medium further causes: determining a state-of-health, a charging specification, a charging duration, and a charging sequence of the one or more second battery packs of the first vehicle. In one embodiment, the non-transitory computer readable storage medium further causes: determining an itinerary information of the first vehicle from one or more databases.

In one embodiment, the non-transitory computer readable storage medium further causes: generating the first response message based on user interactions with the user interactive menu.

In one embodiment, the non-transitory computer readable storage medium further causes: establishing a peer-to-peer connection between the first vehicle and the charging station.

In one embodiment, the first discharge request message comprises information of at least one of the first required charge, a first monetary value, a charging station identification number, a mode of charging, the location of the charging station, an amount of charging needed, a scheduled time period, a charging duration, and a charging sequence. The first response message comprises a first response as one of a confirmation, a negotiation, and a denial. In one embodiment, the non-transitory computer readable storage medium further causes: transmitting power to the charging station upon sending the first response as the confirmation. In one embodiment, the non-transitory computer readable storage medium further causes: receiving a second discharge request message from the charging station upon sending the first response as one of a negotiation and a denial.

In one embodiment, the first response message comprises a counter message that comprises revised information of at least one of the first required charge, the first monetary value, the charging station identification number, the mode of charging, the location of the charging station, the amount of charging needed, the charging duration, the scheduled time period, and the charging sequence. In one embodiment, the non-transitory computer readable storage medium further causes: receiving one or more user inputs to provide user instructions with the user interactive menu from one of an external device and a dashboard.

In one embodiment, the artificial intelligence engine comprises a machine learning model.

In an embodiment of the system, the machine learning model is configured to learn using labelled data using a supervised learning method, wherein the supervised learning method comprises logic using at least one of a decision tree, a logistic regression, a support vector machine, a k-nearest neighbours, a Naïve Bayes, a random forest, a linear regression, a polynomial regression, and a support vector machine for regression.

In an embodiment of the system, the machine learning model is configured to learn from the real-time data using an unsupervised learning method, wherein the unsupervised learning method comprises logic using at least one of a k-means clustering, a hierarchical clustering, a hidden Markov model, and an apriori algorithm.

In an embodiment of the system, the machine learning model has a feedback loop (error signal), wherein the output from a previous step is fed back to the model in real-time to improve the performance and accuracy of the output of a next step.

In an embodiment of the system, the machine learning model comprises a recurrent neural network model.

In an embodiment of the system, the machine learning model has a feedback loop, wherein the learning is further reinforced with a reward for each true positive of the output of the system.

In an embodiment, the artificial intelligence engine may reside in the cloud. The processor using the artificial intelligence engine may determine the demand percentile score of the charge requester by taking input as count of the charging requests and the first state-of-charge. When the first state-of-charge is less and the count of the charging requests is more, the demand percentile score is high. When the first state-of-charge is high and the count of the charging requests is low, the demand percentile score is less. The artificial intelligence engine is pre-trained using historical data. Based on the training provided, the artificial intelligence engine improves itself and determines the demand percentile score with better accuracy. In one embodiment, the processor is operable to dynamically generate the first discharge request message based on the demand percentile score in real-time. The processor is further operable to dynamically determine the first monetary value based on a demand percentile score in real-time. The artificial intelligence engine is pre-trained using historical data of monetary values based on demand percentile score. Based on the training provided, the artificial intelligence engine improves itself and determines the first monetary value with better business accuracy.

In one embodiment, the processor utilizes the artificial intelligence engine to determine whether to charge the first battery packs of the charging station or to directly distribute the power to the second vehicles via the P2P connection based on the demand percentile score. The processor, utilizing the artificial intelligence engine, may decide to charge the first battery packs of the charging station during night time. The processor, utilizing the artificial intelligence engine, may decide to directly distribute the power to the second vehicles during high demand. The processor using the artificial intelligence may also determine the make, the model, the charging specification, and other configuration of the electric vehicles (first vehicle, second vehicle) from an external database.

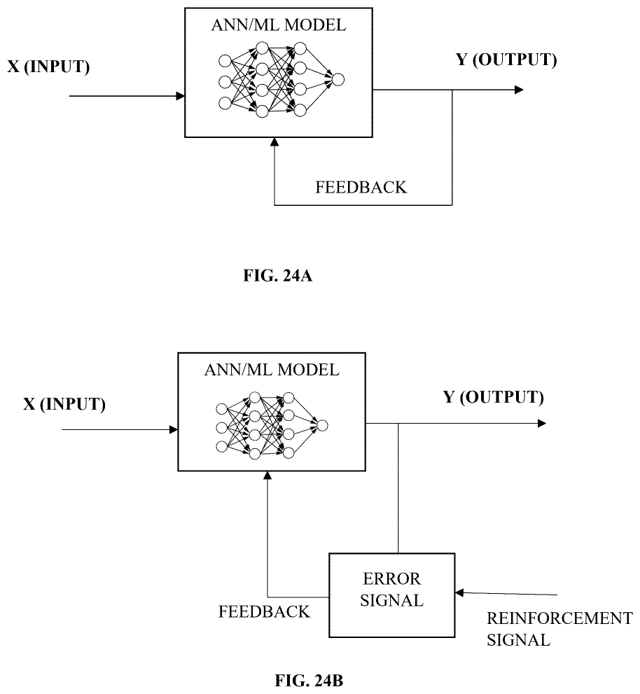

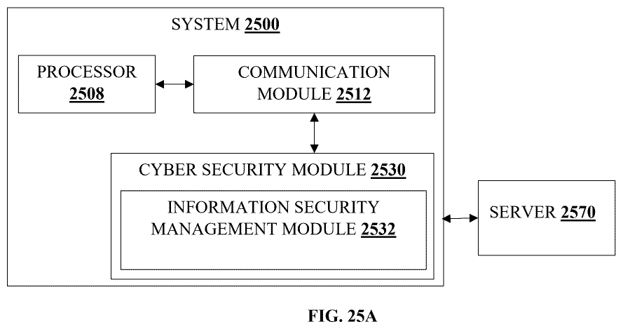

FIG. 24A shows a structure of the neural network/machine learning model with a feedback loop. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may determine monetary value and required charge.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN). Neural Networks can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, and image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback (error signal). The variations of weights in the hidden layer(s) will be adjusted to fit the expected outputs better while training the model. This will allow the model to provide results with far fewer mistakes.

The neural network is featured with the feedback loop to adjust the system output dynamically as it learns from the new data. In machine learning, backpropagation and feedback loops are used to train an AI model and continuously improve it upon usage. As the incoming data that the model receives increases, there are more opportunities for the model to learn from the data. The feedback loops, or backpropagation algorithms, identify inconsistencies and feed the corrected information back into the model as an input.

Even though the AI/ML model is trained well, with large sets of labelled data and concepts, after a while, the models'performance may decline while adding new, unlabelled input due to many reasons which include, but not limited to, concept drift, recall precision degradation due to drifting away from true positives, and data drift over time. A feedback loop in the model keeps the AI results accurate and ensures that the model maintains its performance and improvement, even when new unlabelled data is assimilated. A feedback loop refers to the process by which an AI model's predicted output is reused to train new versions of the model.

Initially, when the AI/ML model is trained, a few labelled samples comprising both positive and negative examples of the concepts (for e.g., monetary value, required charge, etc.) are used that are meant for the model to learn. Afterward, the model is tested using unlabelled data. By using, for example, deep learning and neural networks, the model can then make predictions on whether the desired concept/s (for e.g., monetary value, required charge, etc.) are in unlabelled images. Each image is given a probability score where higher scores represent a higher level of confidence in the models'predictions. Where a model gives an image a high probability score, it is auto labelled with the predicted concept. However, in the cases where the model returns a low probability score, this input may be sent to a controller (may be a human moderator) which verifies and, as necessary, corrects the result. The human moderator may be used only in exception cases. The feedback loop feeds labelled data, auto-labelled or controller-verified, back to the model dynamically and is used as training data so that the system can improve its predictions in real-time and dynamically.

FIG. 24B shows a structure of the neural network/machine learning model with reinforcement learning. The network receives feedback from authorized networked environments. Though the system is similar to supervised learning, the feedback obtained in this case is evaluative not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, the learning is further reinforced with a reward for each true positive of the output of the system. Feedback loops ensure that AI results do not stagnate. By incorporating a feedback loop, the model output keeps improving dynamically and over usage/time.

In an embodiment, icons on a graphical user interface (GUI) or display of the infotainment system of a computer system are re-arranged based on a priority score of the content of the message. The processor tracks the messages that need to be displayed at a given time and generates a priority score, wherein the priority score is determined based on the action that needs to be taken by the user, the time available before the user input is needed, content of the message to be displayed, criticality of the user's input/action that needs to be taken, the sequence of the message or messages that need to be displayed and executed, and the safety of the overall scenario. For example, in case of a health emergency, the messages in queue for displaying could be an emergency signal, type of emergency, intimation that an alert is provided to the nearby vehicles, instructing a path for the driver to pull over, calling the emergency services, etc. In all these messages that need a driver's attention, a priority score is provided based on the actions that need to be taken by the user, the time available for the user to receive the displayed message and react with an action, the content of the message, criticality of the user's input/action, sequence of the messages that need to be executed, and safety of the overall scenario. Considering the above example, the message that intimates the user/driver that an alert has been provided to nearby vehicles may be of lower priority as compared to instructing the path for the driver to pull over. Therefore, the pull over directions for the path message takes priority and takes such a place on the display (example, center of the display) which can grab the users'attention immediately. The priority of the messages are evaluated dynamically as the situation is evolving and thus the display icons, positions, and sizes of the text or icon on the display are changed in real-time and dynamically. In an embodiment, more than one message is displayed and highlighted as per the situation and the user's actions. Further, while pulling over, if an unsafe scenario is found, for example, a car is changing lanes which may obstruct the user's vehicle, the message dynamically changes and warns the driver about the developing scenario. In another scenario of a vehicle with charge less than threshold charge level, the processor dynamically reassigns the priority score and depicts nearby charging station and navigates the route to the charging station onto a display in the dashboard.

In an embodiment, the system further comprises a cyber security module wherein the cyber security module comprises an information security management module providing isolation between the communication module and servers.

In an embodiment, the information security management module is operable to, receive data from the communication module, exchange a security key at a start of the communication between the communication module and the server, receive the security key from the server, authenticate an identity of the server by verifying the security key, analyze the security key for a potential cyber security threat, negotiate an encryption key between the communication module and the server, encrypt the data; and transmit the encrypted data to the server when no cyber security threat is detected.

In an embodiment, the information security management module is operable to exchange a security key at a start of the communication between the communication module and the server, receive the security key from the server, authenticate an identity of the server by verifying the security key, analyze the security key for a potential cyber security threat, negotiate an encryption key between the system and the server, receive encrypted data from the server, decrypt the encrypted data, perform an integrity check of the decrypted data and transmit the decrypted data to the communication module when no cyber security threat is detected.

In an embodiment, the system may comprise a cyber security module.

In one aspect, a secure communication management (SCM) computer device for providing secure data connections is provided. The SCM computer device includes a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system.

According to an embodiment, secure authentication for data transmissions comprises, provisioning a hardware-based security engine (HSE) located in the information security management module, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

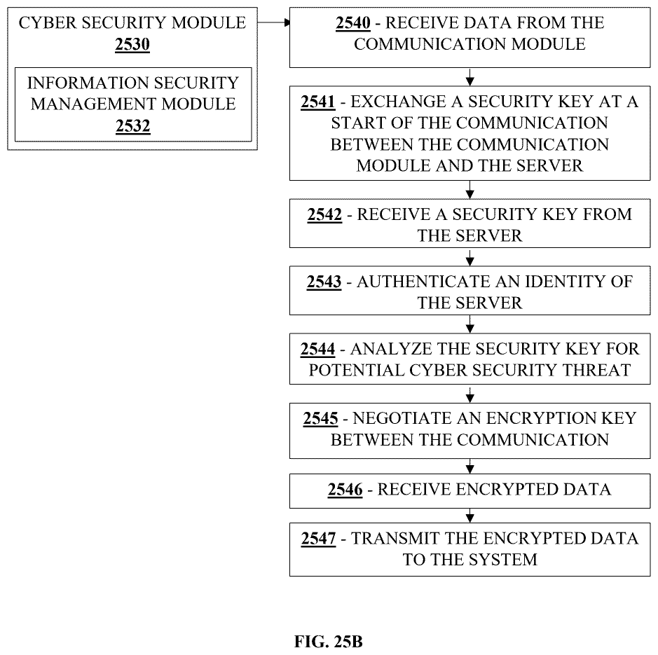

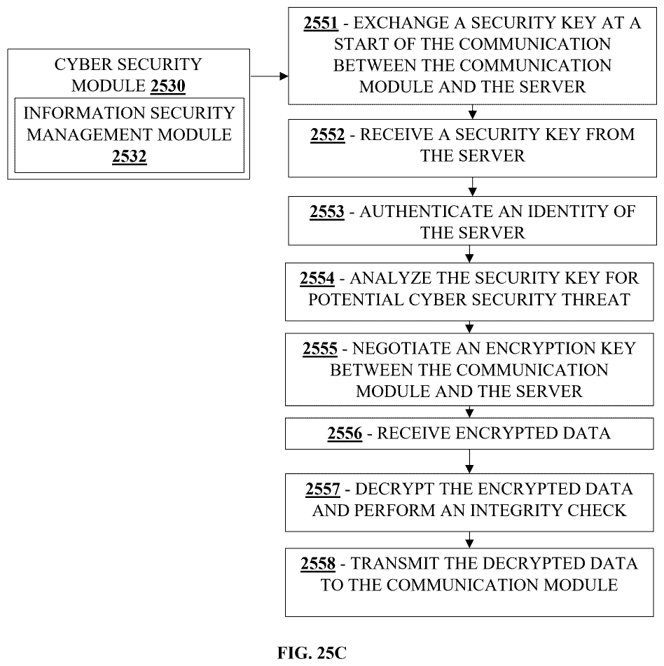

In an embodiment, FIG. 25A shows the block diagram of the cyber security module. The communication of data between the system 2500 and the server 2570, through the processor 2508, through the communication module 2512, is first verified by the information security management module 2532 before being transmitted from the system to the server or from the server to the system. The information security management module is operable to analyze the data for potential cyber security threats, to encrypt the data when no cyber security threat is detected, and to transmit the data encrypted to the system or the server.

In an embodiment, the cyber security module further comprises an information security management module providing isolation between the system and the server. FIG. 25B shows the flowchart of securing the data through the cyber security module 2530. At step 2540, the information security management module 2532 is operable to receive data from the communication module. At step 2541, the information security management module exchanges a security key at a start of the communication between the communication module and the server. At step 2542, the information security management module receives a security key from the server. At step 2543, the information security management module authenticates an identity of the server by verifying the security key. At step 2544, the information security management module analyzes the security key for potential cyber security threats. At step 2545, the information security management module negotiates an encryption key between the communication module and the server. At step 2546, the information security management module receives the encrypted data. At step 2547, the information security management module transmits the encrypted data to the server when no cyber security threat is detected.

In an embodiment, FIG. 25C shows the flowchart of securing the data through the cyber security module 2530. At step 2551, the information security management module 2532 is operable to: exchange a security key at a start of the communication between the communication module and the server. At step 2552, the information security management module receives a security key from the server. At step 2553, the information security management module authenticates an identity of the server by verifying the security key. At step 2554, the information security management module analyzes the security key for potential cyber security threats. At step 2555, the information security management module negotiates an encryption key between the communication module and the server. At step 2556, the information security management module receives encrypted data. At step 2557, the information security management module decrypts the encrypted data, and performs an integrity check of the decrypted data. At step 2558, the information security management module transmits the decrypted data to the communication module when no cyber security threat is detected.

In an embodiment, the integrity check is a hash-signature verification using a Secure Hash Algorithm 256 (SHA256) or a similar method.

In an embodiment, the information security management module is configured to perform asynchronous authentication and validation of the communication between the communication module and the server.

In an embodiment, the information security management module is configured to raise an alarm if a cyber security threat is detected. In an embodiment, the information security management module is configured to discard the encrypted data received if the integrity check of the encrypted data fails.

In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 25A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature.

In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine.

In an embodiment, both communication parties need to authenticate their own identities through a pair of asymmetric keys, and a task in charge of communication with the information security management module of the system is identified by a unique pair of asymmetric keys.

In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key.

In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

Other specific forms may embody the present invention without departing from its spirit or characteristics. The described embodiments are in all respects illustrative and not restrictive. Therefore, the appended claims rather than the description herein indicate the scope of the invention. All variations which come within the meaning and range of equivalency of the claims are within their scope.

1-33. canceled

34. A first vehicle comprising:
a memory; and
a processor that is communicatively coupled to the memory, wherein the processor is operable to:
receive a first discharge request message from a charging station;
analyze the first discharge request message;
extract information of at least a location of the charging station and first required charge from the first discharge request message;
determine whether a state-of-charge of one or more second battery packs of the first vehicle is sufficient to reach the location of the charging station and provide the first required charge to the charging station;
display a user interactive menu onto a display depicting a monetization opportunity and an optimized route to the location of the charging station upon determining that the state-of-charge of the one or more second battery packs of the first vehicle is sufficient to reach the charging station and to provide the first required charge to the charging station; and
generate and communicate a first response message to the charging station based on interaction with the user interactive menu to schedule a discharging event with the charging station.

35. The first vehicle of claim 34, wherein the processor is operable to determine a state-of-health, a charging specification, a charging duration, and a charging sequence of the one or more second battery packs of the first vehicle.

36. The first vehicle of claim 34, wherein the processor is operable to determine an itinerary information of the first vehicle from one or more databases.

37. The first vehicle of claim 34, wherein the processor is operable to generate the first response message based on user interactions with the user interactive menu.

38. The first vehicle of claim 34, wherein the processor is operable to establish a peer-to-peer connection between the first vehicle and the charging station.

39. The first vehicle of claim 34, wherein the first discharge request message comprises information of at least one of the first required charge, a first monetary value, a charging station identification number, a mode of charging, the location of the charging station, an amount of charging needed, a charging duration, a scheduled time period, and a charging sequence.

40. A method comprising:
receiving a first discharge request message from a charging station;
analyzing the first discharge request message;
extracting information of at least a location of the charging station and first required charge from the first discharge request message;
determining whether a state-of-charge of one or more second battery packs of a first vehicle is sufficient to reach the location of the charging station and provide the first required charge to the charging station;
displaying a user interactive menu onto a display depicting a monetization opportunity and an optimized route to the location of the charging station upon determining that the state-of-charge of the one or more second battery packs of the first vehicle is sufficient to reach the charging station and to provide the first required charge to the charging station; and
generating and communicating a first response message to the charging station based on interaction with the user interactive menu to schedule a discharging event with the charging station.

41. The method of claim 40, wherein the first discharge request message comprises information of at least one of the first required charge, a first monetary value, a charging station identification number, a mode of charging, the location of the charging station, an amount of charging needed, a charging duration, a scheduled time period, and a charging sequence.

42. The method of claim 40, wherein the first response message comprises a first response as one of a confirmation, a negotiation, and a denial.

43. The method of claim 42, further comprising: transmitting power to the charging station upon sending the first response as the confirmation.

44. The method of claim 42, further comprising: receiving a second discharge request message from the first vehicle upon sending the first response as one of the negotiation and the denial.

45. The method of claim 41, wherein the first response message comprises a counter message that comprises revised information of at least one of the first required charge, the first monetary value, the charging station identification number, the mode of charging, the location of the charging station, the amount of charging needed, the charging duration, the scheduled time period, and the charging sequence.

46. The method of claim 40, further comprising: receiving one or more user inputs to provide user instructions with the user interactive menu from one of an external device and a dashboard.

47. A non-transitory computer readable storage medium comprising a sequence of instructions, which when executed by a processor causes:
receiving a first discharge request message from a charging station;
analyzing the first discharge request message;
extracting information of at least a location of the charging station and first required charge from the first discharge request message;
determining whether a state-of-charge of one or more second battery packs of a first vehicle is sufficient to reach the location of the charging station and provide the first required charge to the charging station;
displaying a user interactive menu onto a display depicting a monetization opportunity and an optimized route to the location of the charging station upon determining that the state-of-charge of the one or more second battery packs of the first vehicle is sufficient to reach the charging station and to provide the first required charge to the charging station; and
generating and communicating a first response message to the charging station based on interaction with the user interactive menu to schedule a discharging event with the charging station.

48. The non-transitory computer readable storage medium of claim 47, wherein the first discharge request message comprises information of at least one of the first required charge, first a monetary value, a charging station identification number, a mode of charging, the location of the charging station, an amount of charging needed, a scheduled time period, a charging duration, and a charging sequence.

49. The non-transitory computer readable storage medium of claim 47, wherein the first response message comprises a first response as one of a confirmation, a negotiation, and a denial.

50. The non-transitory computer readable storage medium of claim 49, further causes:
transmitting power to the charging station upon sending the first response as the confirmation.

51. The non-transitory computer readable storage medium of claim 49, further causes: receiving a second discharge request message from the first vehicle upon sending the first response as one of the negotiation and the denial.

52. The non-transitory computer readable storage medium of claim 48, wherein the first response message comprises a counter message that comprises revised information of at least one of the first required charge, the first monetary value, the charging station identification number, the mode of charging, the location of the charging station, the amount of charging needed, the charging duration, the scheduled time period, and the charging sequence.

53. The non-transitory computer readable storage medium of claim 47, further causes: receiving one or more user inputs to provide user instructions with the user interactive menu from one of an external device and a dashboard.
